(19) United States
(12) Patent Application Publication
(10) Pub. No.: US 2025/0124478 A1
(43) Pub. Date: Apr. 17, 2025

(54) SYSTEM, MANAGEMENT SERVER, CONTROL METHOD OF MANAGEMENT SERVER, AND STORAGE MEDIUM

(71) Applicant: NEC Corporation, Minato-ku, Tokyo (JP)

(72) Inventor: Yusuke SATO, Tokyo (JP)

(73) Assignee: NEC Corporation, Minato-ku, Tokyo (JP)

(21) Appl. No.: 18/834,665

(22) PCT Filed: Mar. 1, 2022
(86) PCT No.: PCT/JP2022/008477

§ 371 Date: Jul. 31, 2024

(51) Int. Cl. G06Q 30/0283

(52) U.S. Cl. CPC G06Q 30/0283

(57) ABSTRACT

A system includes a distribution control server and a management server. The distribution control server controls data accumulation to make data related to a service that is provided to a user from a data accumulator a target for data distribution. The distribution control server controls data sharing for a data sharing destination to acquire the accumulated data. The distribution control server controls data providing for a data providing destination to acquire the accumulated data. The management server charges an accumulation platform usage fee related to the data accumulation to the data accumulator. The management server charges a sharing platform usage fee related to data sharing to the data sharing destination. The management server charges a providing platform usage fee related to data providing to the data providing destination.

### TECHNICAL FIELD

The present invention relates to a system, a management server, a control method of a management server, and a storage medium.

### BACKGROUND ART

There are information distribution systems that provide personal information held by hospitals and the like to apparatuses of information providing destinations, such as business operator, based on consents of individuals.

For example, Patent Literature 1 discloses an information transaction apparatus connected to an information holding apparatus that includes a storage unit that stores personal information. The information transaction apparatus includes a sharing approval reception unit, a providing approval reception unit, a sharing instruction unit, and a providing instruction unit. The sharing approval reception unit accepts approval for sharing personal information by an information sharing destination apparatus from a user associated with the personal information. The providing approval reception unit accepts approval of providing, which is a transmission of the personal information to information providing destination apparatus, from the user associated with the personal information. The sharing instruction unit instructs the information sharing destination apparatus to share when the sharing approval reception unit accepts the approval for sharing. The providing instruction unit instructs the information holding apparatus to provide when the providing approval reception unit accepts the approval of providing.

### CITATION LIST

### Patent Literature

[PTL 1] International Publication WO2021/085064

### SUMMARY OF INVENTION

### Technical Problem

As disclosed in Patent Literature 1, actors in the information distribution system include an information holder who stores personal information (personal data), an information providing destination who acquires the personal information by sharing, and an information providing destination who acquires the personal information by providing. In addition, there are information distribution business operators that provide a platform for the information distribution system.

Here, operating the information distribution system requires costs, and each actor is required to bear the costs for operating the information distribution system. However, if the burden of the costs is biased toward any one actor, there is a possibility that the information distribution system may not be able to continue to operate.

Note that this problem cannot be solved by applying the technology disclosed in Patent Literature 1. In Patent Literature 1, the costs of operating the information distribution system are not taken into consideration.

It is a main object of the present invention to provide a system, a management server, a control method for a management server, and a storage medium that contribute to making an information distribution system sustainable.

### Solution to Problem

According to a first aspect of the present invention, there is provided a system including: a distribution control server that controls data accumulation to make data related to a service that is provided to a user from a data accumulator a target for data distribution, controls data sharing for a data sharing destination to acquire the accumulated data, and controls data providing for a data providing destination to acquire the accumulated data; and a management server that charges an accumulation platform usage fee related to the data accumulation to the data accumulator, charges a sharing platform usage fee related to the data sharing to the data sharing destination, and charges a providing platform usage fee related to the data providing to the data providing destination.

According to a second aspect of the present invention, there is provided a management server including: a transaction history control unit that acquires a data accumulation history regarding data accumulation to make data related to a service that is provided to a user from a data accumulator a target for data distribution, acquires a data sharing history regarding data sharing for a data sharing destination to acquire the accumulated data, and acquires a data providing history regarding data providing for a data providing destination to acquire the accumulated data; and a transaction settlement control unit that calculates an accumulation platform usage fee related to the data accumulation based on the data accumulation history and charges the calculated accumulation platform usage fee to the data accumulator, calculates a sharing platform usage fee related to the data sharing based on the data sharing history and charges the calculated sharing platform usage fee to the data sharing destination, and calculates a providing platform usage fee related to the data providing based on the data providing history and charges the calculated providing platform usage fee to the data providing destination.

According to a third aspect of the present invention, there is provided a control method of a management server, the control method including: acquiring a data accumulation history regarding data accumulation to make data related to a service that is provided to a user from a data accumulator a target for data distribution; acquiring a data sharing history regarding data sharing for a data sharing destination to acquire the accumulated data; acquiring a data providing history regarding data providing for a data providing destination to acquire the accumulated data calculating an accumulation platform usage fee related to the data accumulation based on the data accumulation history and charging the calculated accumulation platform usage fee to the data accumulator; calculating a sharing platform usage fee related to the data sharing based on the data sharing history and charging the calculated sharing platform usage fee to the data sharing destination; and calculating a providing platform usage fee related to the data providing based on the data providing history and charging the calculated providing platform usage fee to the data providing destination.

According to a fourth aspect of the present invention, there is provided a computer-readable storage medium storing a program causing a computer mounted on a management server to perform processing for: acquiring a data accumulation history regarding data accumulation to make data related to a service that is provided to a user from a data accumulator a target for data distribution, acquires a data sharing history regarding data sharing for a data sharing destination to acquire the accumulated data, and acquires a data providing history regarding data providing for a data providing destination to acquire the accumulated data; and calculating an accumulation platform usage fee related to the data accumulation based on the data accumulation history and charges the calculated accumulation platform usage fee to the data accumulator, calculates a sharing platform usage fee related to the data sharing based on the data sharing history and charges the calculated sharing platform usage fee to the data sharing destination, and calculates a providing platform usage fee related to the data providing based on the data providing history and charges the calculated providing platform usage fee to the data providing destination.

### Advantageous Effects of Invention

The individual aspects of the present invention provide a system, a management server, a control method of a management server, and a storage medium that contribute to making an information distribution system sustainable. The advantageous effect of the present invention is not limited to the above advantageous effect. The present invention may provide other advantageous effects, instead of or in addition to the above advantageous effect.

### BRIEF DESCRIPTION OF THE DRAWINGS

FIG. 1 is a diagram illustrating an outline of an example embodiment.

FIG. 2 is a flowchart illustrating an example of an operation of an example embodiment.

FIG. 3 is a diagram illustrating an example of a schematic configuration of an information distribution system according to a first example embodiment.

FIG. 4 is a diagram illustrating an operation of the information distribution system according to the first example embodiment.

FIG. 5 is a diagram illustrating an operation of the information distribution system according to the first example embodiment.

FIG. 6 is a diagram illustrating an operation of the information distribution system according to the first example embodiment.

FIG. 7 is a diagram illustrating an operation of the information distribution system according to the first example embodiment.

FIG. 8 is a diagram illustrating an operation of the information distribution system according to the first example embodiment.

FIG. 9 is a diagram illustrating an example of catalog information according to the first example embodiment.

FIG. 10 is a diagram illustrating an operation of the information distribution system according to the first example embodiment.

FIG. 11 is a diagram illustrating a consideration of the information distribution system according to the first example embodiment.

FIG. 12 is a diagram illustrating an operation of the information distribution system according to the first example embodiment.

FIG. 13 is a diagram illustrating an operation of the information distribution system according to the first example embodiment.

FIG. 14 is a diagram illustrating an example of a processing configuration of a distribution control server according to the first example embodiment.

FIG. 15 is a diagram illustrating an example illustrating an example of a part of a user information database according to the first example embodiment.

FIG. 16 is a diagram illustrating an example database of a location information database according to the first example embodiment.

FIG. 17 is a diagram illustrating an example of a processing configuration of a service server according to the first example embodiment.

FIG. 18 is a diagram illustrating an example of a customer information database according to the first example embodiment.

FIG. 19 is a diagram illustrating an example of a data accumulation history database according to the first example embodiment.

FIG. 20 is a diagram illustrating an example of a data sharing history database according to the first example embodiment.

FIG. 21 is a diagram illustrating an example of a data providing history database according to the first example embodiment.

FIG. 22 is a diagram illustrating an example of a processing configuration of a transaction server according to the first example embodiment.

FIG. 23 is a diagram illustrating an example of an account holder list according to the first example embodiment.

FIG. 24 is a diagram illustrating an example of a processing configuration of a terminal according to the first example embodiment.

FIG. 25 is a diagram illustrating an example of a processing configuration of a management server according to the first example embodiment.

FIG. 26 is a diagram illustrating an example of an accumulation history database according to the first example embodiment.

FIG. 27 is a diagram illustrating an example of a sharing history database according to the first example embodiment.

FIG. 28 is a diagram illustrating an example of a providing history database according to the first example embodiment.

FIG. 29 is a diagram illustrating an example of an accumulation consideration payment statement according to the first example embodiment.

FIG. 30 is a diagram illustrating an example of a sharing consideration payment instruction statement according to the first example embodiment.

FIG. 31 is a diagram illustrating an example of a providing consideration payment instruction statement according to the first example embodiment.

FIG. 32 is a diagram illustrating an example of an income and expenditure management database according to the first example embodiment.

FIG. 33 is a flowchart illustrating an example of an operation of the management server according to the first example embodiment.

FIG. 34 is a diagram illustrating an example of the hardware configuration of the management server of the present application.

### EXAMPLE EMBODIMENT

First, an outline of an example embodiment will be described. In the following outline, various components are denoted by reference characters for the sake of convenience. That is, the following reference characters are used as examples to facilitate the understanding of the present invention. Thus, the description of the outline is not intended to impose any limitations. In addition, unless otherwise specified, an individual block illustrated in the drawings represents a configuration of a functional unit, not a hardware unit. An individual connection line between blocks in the drawings signifies both one-way and two-way directions. An arrow schematically illustrates a principal signal (data) flow and does not exclude bidirectionality. In the present description and drawings, elements that can be described in a like way will be denoted by a like reference character, and redundant description thereof will be omitted as needed.

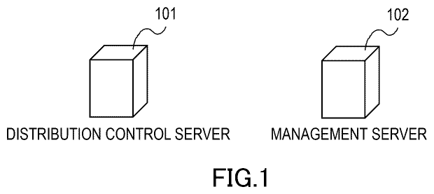

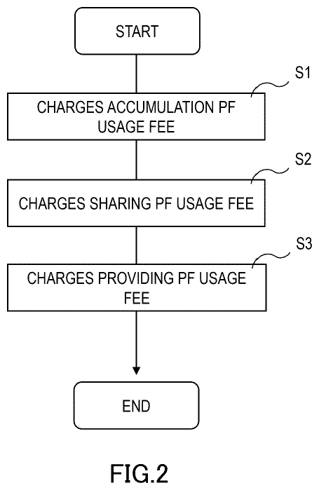

A system according to an example embodiment includes a distribution control server 101 and a management server 102 (see FIG. 1). The distribution control server 101 controls data accumulation to make data related to a service that is provided to a user from a data accumulator a target for data distribution. The distribution control server 101 controls data sharing for a data sharing destination to acquire the accumulated data. The distribution control server 101 controls data providing for a data providing destination to acquire the accumulated data. The management server 102 charges an accumulation platform (PF; Platform) usage fee related to the data accumulation to the data accumulator (step S1 in FIG. 2). The management server 102 charges a sharing platform usage fee related to data sharing to the data sharing destination (step S2). The management server 102 charges a providing platform usage fee related to data providing to the data providing destination (step S3).

The management server 102 determines a platform usage fee so that three entities, that is, the data accumulator, the data sharing destination, and the data providing destination, share operating costs necessary for operating the information distribution system, and charges payment of the usage fee to the three entities. By dividing the operating costs into three usage fees, the management server 102 can give preferential treatment to a certain entity or have a certain entity bear more costs. For example, in the information distribution system, when accumulated data does not exist, data sharing and data providing do not occur, so the management server 102 determines the accumulation platform usage fee so as to give preferential treatment to the data accumulator. The data accumulator who is given a preferential usage fee can accumulate more data and provide many data to the data sharing destination or the data providing destination. The data sharing destination and data providing destination generate revenue by using the data obtained through data distribution to provide a better service to a user. Therefore, each actor can generate revenue, and there is no concern that each actor in the information distribution system may withdraw from the system, and so on. As a result, the information distribution system continues to operate (the information distribution system becomes sustainable).

Hereinafter, specific example embodiments will be described in more detail with reference to drawings.

### First Example Embodiment

A first example embodiment will be described in more detail with reference to drawings.

### [System Configuration]

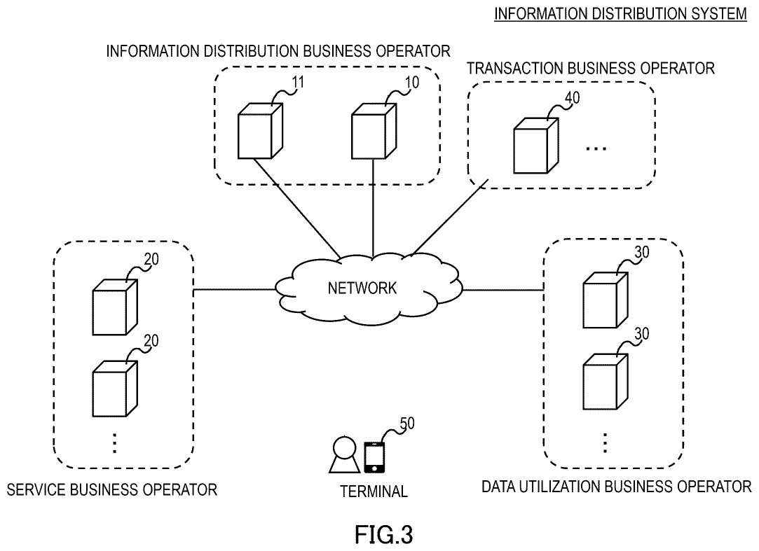

FIG. 3 is a diagram illustrating an example of a schematic configuration of an information distribution system according to a first As shown in FIG. 3, participating members example embodiment. (actors) of the information distribution system include an information distribution business operator, service business operators, data utilization business operators, and transaction business operators.

The information distribution business operator is a business operator that provides a platform for a data distribution service (information distribution service) of personal data accumulated by the service business operators. The information distribution business operator controls data distribution among the business operators (the service business operators and the data utilization business operators). The information distribution business operator includes a distribution control server 10 and a management server 11.

The distribution control server 10 is a server apparatus that controls (realizes) the data distribution between the service business operators and controls the data distribution between the service business operator and the data utilization business operator. The distribution control server 10 realizes an information distribution service for data retained by the service business operators.

The management server 11 is a server apparatus that is responsible for management and the like related to an operation of the information distribution system. The management server 11 mainly manages financial aspects, such as costs required to operate the information distribution system, fees collected from the service business operators participating in the information distribution system, and compensation for the data distribution.

The service business operator is an entity that provides a service to an individual. The service business operator may be a private business operator or a public institution. Examples of the service business operators include a medical institution (hospital, pharmacy, and so on) that provides a medical service to a user, a retailer, an education business operator or the like that teaches a language, sport, art, and so on to a customer.

Each service business operator includes a service server 20 to provide a service to a customer. The service server 20 is managed and operated by the service business operator. The service server 20 retains (stores) data generated by the service business operator when the service business operator provides a service to a user, data, and so on necessary to provide a service to a user. The service business operator retains user data related to the service that the service business operator provides the service to the user.

The data utilization business operator is an entity that does not provide a service directly to an individual. An example of the data utilization business operator is a business operator such as a pharmaceutical company. For example, the pharmaceutical company develops a new drug using data acquired from the service business operator.

Note that in the present application, the entity that does not provide a service to an individual is treated and described as the “data utilization business operator”, but it is natural that the data utilization business operator acts as the “service business operator” when the data utilization business operator provides the service to the user. In other words, depending on a business model of the data utilization business operator, the data utilization business operator may also be the service business operator.

The data utilization business operator includes a data utilization server 30 for acquiring data from the service business operator and utilizing the data.

The transaction business operator is an entity that realizes a transaction between the service business operator and the data utilization business operator. The transaction business operator realizes data distribution between a data generator (the service business operator) and a data consumer (the data utilization business operator).

The transaction business operator includes a transaction server 40 to realize the data distribution.

A user who uses the information distribution system uses a terminal 50.

Each apparatus shown in FIG. 3 is connected to each other via a network. For example, the distribution control server 10 and the service server 20 are each connected by wired or wireless communication means so that the distribution control server 10 and the service server 20 can communicate with each other.

The configuration illustrated in FIG. 3 is an example and does not limit the configuration and so on of the information distribution system disclosed in the present application. For example, the information distribution business operator may include two or more distribution control servers 10. Furthermore, with respect to the transaction business operator and the data utilization business operator, the information distribution system includes the data utilization server 30 and the transaction server 40, which correspond to the number of the business operators that participate in the system.

### [Schematic Operation of System]

Next, a schematic operation of the information distribution system according to the first example embodiment will be described.

A user enters into an individual contract with a service business operator from whom the user wishes to receive a service. For example, the user provides his or her name and the like to the service business operator and offers to enter into a new contract (a contract for receiving the service) with the service business operator.

For example, the user who wishes to visit a hospital submits health insurance card, or the like, which is described with his or her name, or the like, to the hospital. Alternatively, for an EC (Electronic Commerce) business operator that provides a service related to an online shopping service, the user accesses the service server 20 operated by the EC business operator and creates an account.

The service business operator generates a “personal identification ID” to identify a new customer (user). For example, a hospital assigns a patient card number to manage the user (patient), and generates the patient card number as the personal identification ID. An EC business operator generates a membership number or the like to manage the customer as the personal identification ID. The service server 20 stores the generated personal identification ID (for example, patient card number or membership number, and so on) in a database or the like.

Once the personal identification ID is generated, the user can receive a service provided from the service business operator. For example, the user receives a medical service (such as a health checkup or consultation) from the hospital. Or, the user uses an EC business operator to do an online shopping.

In order to make user data generated by the service business operator when the service business operator has provided a service to a user, and so on, a target for the data distribution, “accumulation” of data is necessary. Data accumulation means that the service business operator (a provider of the user data) registers the user data as data that can be provided to a third party in an information distribution system. The distribution control server 10 controls data accumulation to make data related to a service provided to a user from a data accumulator (service business operator) a target of data distribution.

Accumulated data becomes the target of the data distribution. In addition, accumulation of user data requires agreement (consent to data accumulation) from the user (the user who is a source of generation of user data).

“Sharing” and “providing” exist as means of the data distribution in the information distribution system.

“Sharing” is a means for the service business operator to acquire data accumulated by other service business operators. For example, data distribution through “sharing” is used when the EC business operator acquires data that has been generated by providing a service to a user by a hospital. The EC business operator uses the data acquired from the hospital by data sharing to provide a better service to the user.

“Providing” is means for the data utilization business operator to acquire data accumulated by other service business operators. For example, data distribution by “providing” is used when a pharmaceutical company acquires results of a medical checkup or a medical examination from a hospital. The pharmaceutical company uses the data acquired from the hospital by data providing to help develop a new drug.

The distribution control server 10 controls data sharing for a data sharing destination (the service business operator who receives supply of data) to acquire the accumulated data. The distribution control server 10 controls data providing for a data providing destination (the data utilization business operator who receives supply of data) to acquire the accumulated data.

### <Generation of System Account>

A user of the information distribution system is required to register in advance (user registration, system registration). More specifically, the user accesses the distribution control server 10 and performs a procedure to generate an account. In the following description, an account generated in the information distribution system will be described as a “system account”

The user accesses the distribution control server 10 by operating the terminal 50 that the user possesses in order to generate the system account. In response to access from the terminal 50, the distribution control server 10 displays a WEB (web) page for generating the system account.

The user performs an operation to generate the system account (for example, by pressing a predetermined button) and generates the system account. At that time, the distribution control server 10 acquires information necessary to generate the system account for the user. Specifically, the distribution control server 10 acquires the user's login information (login ID and password) and personal information (name, date of birth, contact information, account information, and so on).

When the distribution control server 10 acquires the login information, personal information, or the like, the distribution control server 10 generates a user ID (Identifier) to uniquely identify the user in the information distribution system.

The distribution control server 10 stores the generated user ID, login information, and personal information (for example, name, date of birth, and contact information), and so on, of the user in association with each other. The distribution control server 10 stores these information in a “user information database”. Details of the user information database will be described below.

The distribution control server 10 issues the generated user ID to the user (the terminal 50). The terminal 50 stores the issued user ID.

### <Linking of IDs>

As described above, “data accumulation” is necessary to make user data retained by the service business operator a target of data distribution. To realize the data accumulation, it is necessary to link an ID of the system account (user ID) with an ID generated by the service business operator (personal identification ID).

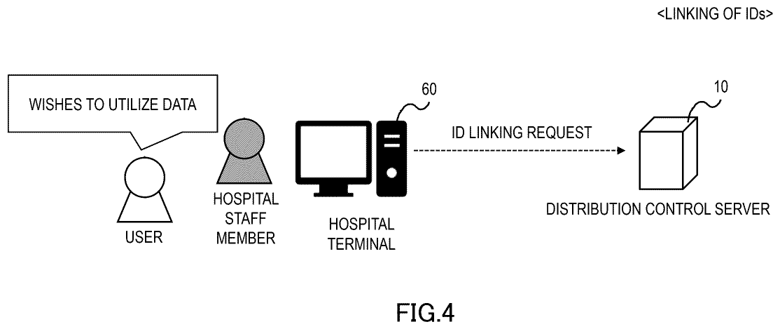

For example, as shown in FIG. 4, a user informs a hospital staff member at a counter of the hospital that he or she wishes to utilize user data retained by the hospital (the user applies for data utilization). The hospital staff member inputs personal identifying information of the user, personal identification ID of the user (for example, patient card number), and business operator code into a hospital terminal 60.

Note that the personal identifying information is information that identifies the user. Examples of the personal identifying information include name of the user, or combination of the name and date of birth of the user.

Additionally, the business operator code is an identification information (ID) to identify the service business operator that participates in the information distribution system. For example, different codes are assigned to a hospital and an EC business operator. The business code is shared among participants in the information distribution system (the information distribution business operator, the service business operator, and the data utilization business operator) by an arbitrary means. For example, when the service business operator participates in the information distribution system, the information distribution business operator generates a business operator code to be assigned to the service business operator. The information distribution business operator notifies the service business operator, or the like, of the generated business operator code.

The hospital terminal 60 transmits an “ID linking request” that includes the acquired personal identifying information, personal identification ID and business operator code to the distribution control server 10.

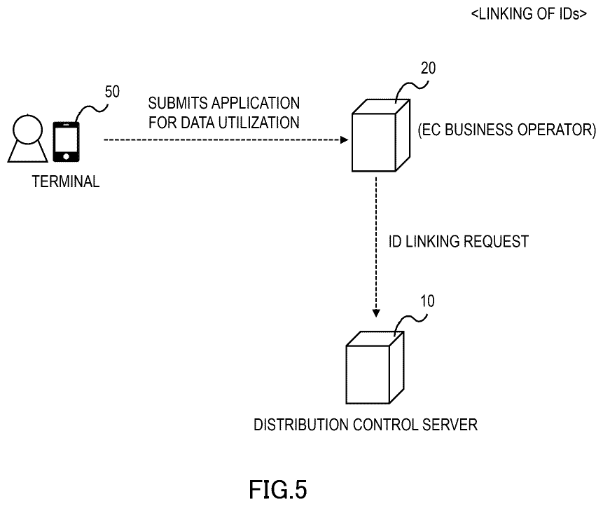

Alternatively, a user who wishes to utilize user data of the EC business operator accesses the service server 20 of the EC business operator by operating the terminal 50 (see FIG. 5). The user logs into the account of the EC business operator and submits an application for data utilization on the account. In response to the application, the service server 20 transmits the “ID linking request” that includes the personal identifying information of the user, the personal identification ID, and the business operator code to the distribution control server 10.

The distribution control server 10 acquires the personal identifying information of a person who wishes to link IDs, the personal identification ID, and the business operator code of the service business operator (for example, hospital, EC business operator) that is a target of ID linking from the hospital terminal 60 or the service server 20.

The distribution control server 10 identifies the service business operator that is the target of the ID linking from the business operator code. In addition, the distribution control server 10 identifies the user registered in the system account from the personal identifying information, and associates the service business operator with the personal identification ID in the account of the identified user.

Once the personal identification ID is registered in the system account (when ID linking is completed), the service business operator that has become the target of the ID linking can “accumulate” the user data of the user who wishes to utilize the data.

Note that the “application for data utilization” by the user to the service business operator can be regarded as agreement (consent) for the service business operator to accumulate the user data. In addition, the service business operator (the service server 20) acquires account information (for example, bank account and credit card information) of the person who wishes to link IDs, and stores the account information in association with the personal identification ID and so on.

### <Data Accumulation>

When the service business operator provides a service to a user, the service business operator stores a personal identification ID of the user and user data (personal data) of the user in association with each other.

With respect to the user for whom ID linking has been completed (the user who has applied for data utilization), the service business operator transmits “location information” to the distribution control server 10 each time user data (data resulting from providing the service, data necessary for providing the service) is stored.

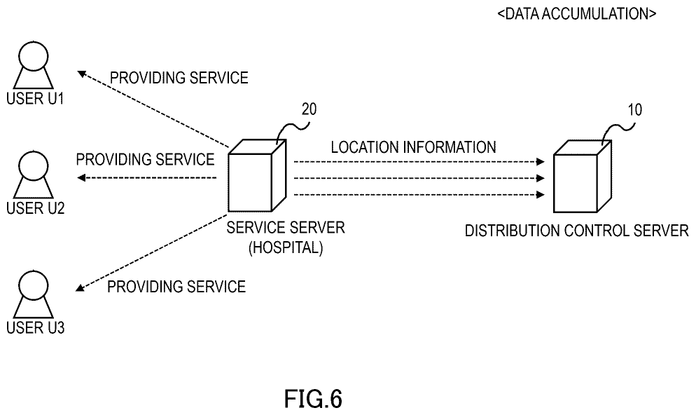

For example, as shown in FIG. 6, when a hospital provides a medical service to each of users U1-U3, the hospital retains the results for each user. For example, the hospital retains the results of the medical examination (disease name; data for example, data such as stomach cancer, lung cancer, and so on) for each of users U1 to U3.

The service business operator (the service server 20) stores the personal identification ID of each user in association with the user data acquired as the result of providing the service. For example, in the example of FIG. 6, the service server 20 uses the “customer information database” to store the personal identification ID of each user U1 to U3 in association with the results of the medical examination. Note that details of the customer information database will be described below.

Each time the service business operator stores the user data concerning the user who has consented to accumulate data, the service business operator transmits “location information” to the distribution control server 10. The location information is information about storing location of user data (entity accumulating the data; the service business operator), and so on. The location information includes the personal identification ID, the business operator code, and a type of data to be retained, and so on.

The distribution control server 10 stores the acquired location information in a “location information database”. Details of the location information database will be described below. The location information database stores the personal identification ID, the business operator code, and the data type, and so on, in association with each other.

### <Data Sharing>

The service business operator that wishes to acquire data accumulated by other service business operators (user data resulting from providing a service to a user by other service business operators) acquires the data by “sharing”.

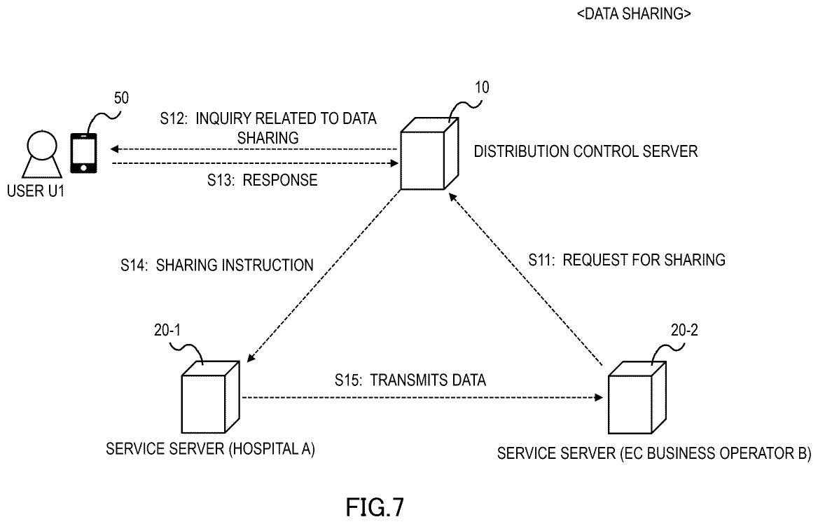

Here, with reference to FIG. 7, a case in which EC business operator B acquires data (medical examination results) of a user accumulated in Hospital A by “sharing” will be described. Note that the hospital includes a service server 20-1 and the EC business operator includes a service server 20-2.

EC business operator B (the service server 20-2) transmits a “request for sharing” to the distribution control server 10 (step S11).

Based on the request for sharing, the distribution control server 10 identifies the user U1 who is a target person for data distribution and a data accumulator (Hospital A) of the data to be distributed. The distribution control server 10 transmits an inquiry regarding the data sharing to the terminal 50 possessed by the identified target (step S12).

The terminal 50 that has received the inquiry for the data sharing acquires an intention of the user U1 related to the data sharing. For example, terminal 50 acquires the intention of the user U1 using a GUI (Graphical User Interface). In the above example, the terminal 50 displays a GUI with content such as “You can receive better service by sharing your medical examination results of hospital with the EC business operator. Would you like to share?” and acquire the intention of the user U1 (consent or non-consent to data sharing).

The terminal 50 transmits a response to the inquiry for the data sharing (consent to data sharing or refuse data sharing) to the distribution control server 10 (step S13).

When the distribution control server 10 acquires the consent of the user U1, the distribution control server 10 transmits a sharing instruction to the data accumulator (Hospital A) (step S14).

Hospital A (the service server 20-1) that has received the sharing instruction refers to the customer information database and transmits the results of the medical examination of the target user U1 to the service server 20-2, which is the designated data sharing destination (step S15).

Next, data distribution by “providing” will be described.

### <Opening an Account>

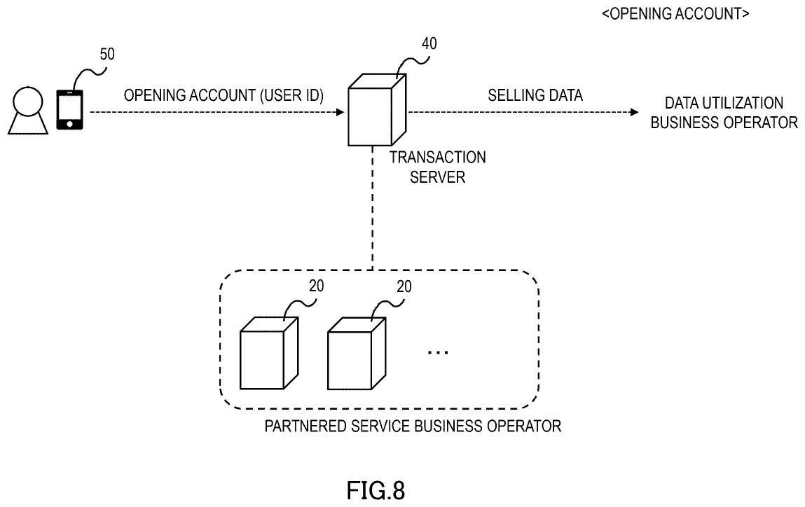

A user who wishes to acquire consideration by providing data needs to open an account with the transaction business operator. With reference to FIG. 8, the opening of an account for providing will be described.

The transaction business operator partners with at least one or more of a plurality of service business operators that participate in the information distribution system. For example, the transaction business operator that handles data related to medical care partners with a medical institution (hospital, pharmacy, and so on). Or, the transaction business operator that handles data related to education partners with the education business operator. The transaction business operator stores the business operator codes related to the partnered service business operators.

Moreover, the transaction business operator stores business operator codes of the data utilization business operators. For example, the transaction business operator generates the business operator code of the data utilization business operator when the transaction business operator starts a transaction with the data utilization business operator. The business operator code of the data utilization business operator is shared among the information distribution business operator, the transaction business operator, and the data utilization business operators by an arbitrary method.

The transaction business operator sells data (accumulated data) retained by the partnered service business operator to the data utilization business operator. For example, when the partnered service business operator shown in FIG. 8 is a medical institution, the transaction business operator sells the data retained by the partnered medical institution to a pharmaceutical company, and so on. All or part of the consideration acquired from the sale of the data is paid to a user involved in the provided data.

As described above, the user who wishes to acquire consideration by providing data through the transaction business operator needs to open an account with the transaction business operator (the transaction server 40). Among users who participate in the information distribution system, those who wish to earn revenue by providing data open an “information account” on the transaction server 40.

The user presents a user ID issued by the distribution control server 10 to the transaction server 40 to open the information account. The transaction server 40 stores the acquired user ID. The transaction server 40 manages the user IDs of the users who have opened the account by means of a list of account holders.

### <Catalog Information>

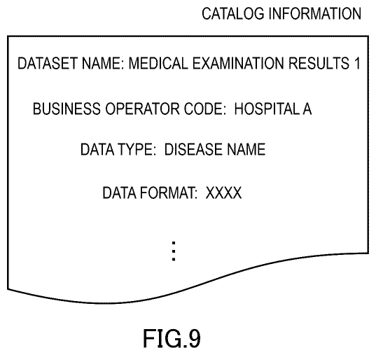

In order to realize data distribution by “providing”, the information distribution business operator prepares catalog information. A person in charge of the information distribution business operator (system administrator) defines the catalog information that describes data that can be sold (see FIG. 9). The catalog information is information that indicates details of data that can be sold by the information distribution system to the data utilization business operator.

A dataset name included in the catalog information shown in FIG. 9 is information that identifies the catalog information. For example, a dataset related to a health checkup is provided with a dataset name such as “medical examination results 1” and a dataset related to medical examination results is provided with a dataset name such as “medical examination results 1”.

The catalog information includes a business operator code of the service business operator that handles the dataset. The data type indicates the type of data (accumulated data that can be provided to a third party) retained by the service business operator. For example, “height”, “weight”, and “blood pressure” of medical examination results, and “disease name”, “medication”, and “test results” of medical examination results correspond to the data type. A data format specifies what kind of format the data is provided in.

The data utilization business operator acquires the catalog information via the transaction business operator. More specifically, the data utilization server 30 transmits a “catalog information presentation request” to the transaction server 40.

When the transaction server 40 receives the request to present catalog information, the transaction server 40 transmits a “request to transmit catalog information” to the distribution control server 10.

In response to receiving the request to transmit catalog information, the distribution control server 10 transmits the catalog information defined by the information distribution business operator to the transaction server 40.

The transaction server 40 selects catalog information about the partnered service business operator and transmits the catalog information to the data utilization server 30. For example, in the above example, the transaction server 40 selects the catalog information about an operation of a pharmaceutical company and transmits to the data utilization business operator. The data utilization business operator views the received catalog information and identifies the catalog information necessary for its own business.

### <Data Distribution by Providing>

The data utilization business operator who wishes to acquire data accumulated by the service business operator acquires the data by “providing”.

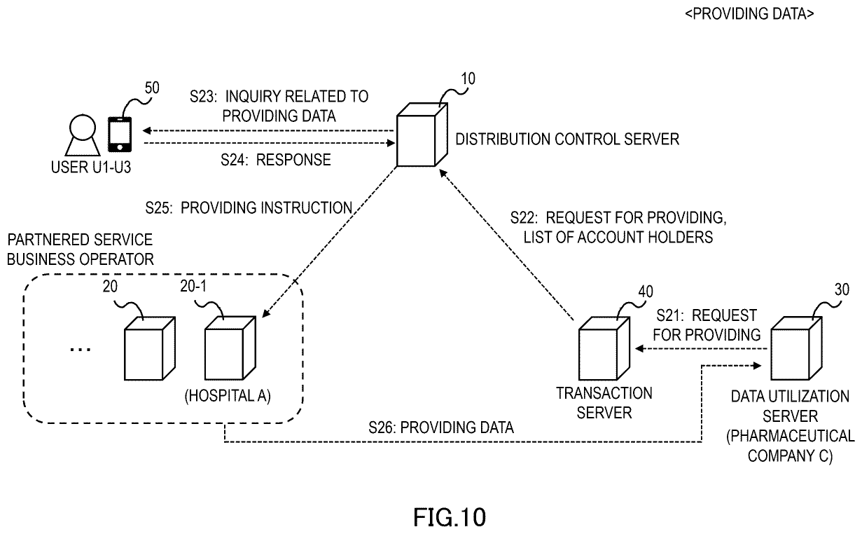

Here, with reference to FIG. 10, a case in which Pharmaceutical Company C acquires stored data (medical examination results) from Hospital A by “providing” will be described.

First, a person in charge of the pharmaceutical company, or the like, refers to the catalog information presented by the transaction business operator and identifies the necessary catalog information. After that, the data utilization server 30, in accordance with the instruction of the person in charge, transmits a request for providing that includes information on the data utilization business operator, a name of a dataset of the identified catalog information, and conditions required for the data to be provided to the transaction server 40 (step S21). Note that in the following description, the conditions required for the data to be provided will be described as “search conditions”

Information on the data utilization business operator includes a name of the data utilization business operator, a business operator code, and a data providing destination (an address to which the data is transmitted), and so on. The search condition includes, for example, “100 or more data on disease names”.

The transaction server 40 examines the acquired request for providing. When no problems are found during the examination, the transaction server 40 transmits the acquired request for providing and a list of account holders to the distribution control server 10 (step S22).

The distribution control server 10 identifies a personal identification ID of a user who is described on the list of account holders and who is related to the requested catalog information. The distribution control server 10 transmits an inquiry related to providing data to a contact information (an e-mail address that can be received by the terminal 50) of the user corresponding to the identified personal identification ID (step S23).

The inquiry for providing data includes information on the source of the request for providing data (Pharmaceutical Company C in the example of FIG. 10), information on the data accumulator (Hospital A in the example of FIG. 10), and information on the data type that is requested to be provided (for example, disease name).

When the terminal 50 receives the inquiry for providing data, the terminal 50 displays a GUI to acquire an intention of each user related to providing the data. The terminal 50 acquires the intention of the user (consent or non-consent to provide data) using the GUI.

The terminal 50 transmits a response to the inquiry for providing data (consent to provide data or refuse to provide data) to the distribution control server 10 (step S24).

The distribution control server 10 transmits a providing instruction to the data accumulator (Hospital A) with respect to the user whose consent has been acquired (step S25). For example, when 100 or more cases of disease name data are requested to be provided as described above, the distribution control server 10 transmits the providing instruction to the service server 20-1 related to the disease name data of 100 or more users who have consented to provide the data.

The Hospital A (the service server 20-1) that receives the providing instruction refers to the customer information database and transmits the user data of the user who has consented to a designated data providing destination (step S26). In the above example, when each of the users U1 to U3 has consented to provide data, the disease name data of the users that includes the users U1 to U3 is transmitted to the data utilization server 30.

### <Generation of Consideration>

Here, consideration associated with an operation (utilization) of the information distribution system will be described.

“Accumulation” means that user data retained by the service business operator is a target for information distribution (data distribution), and consideration is paid to a user who has consented to accumulate the data. In addition, the consideration is also paid to the service business operator that retains the accumulated data (user data of the user who has consented to utilize data).

Since “sharing” is used to improve convenience for a user himself/herself who uses a service, no consideration (consideration for the user) is paid to the user for data distribution. This is because “sharing” is used to utilize data accumulated by other service business operators in order for the user to receive a better service from the service business operator. However, when the “sharing” is performed, consideration is paid from a data acquirer (data sharing destination) to a data sharing source (data accumulator).

Since “providing” is a means used by the data utilization business operator that does not directly provide a service to the user, consideration for the data distribution (consideration for the user) is generated. In other words, when “providing” is performed, consideration is paid to the user. In addition, as with “sharing”, when “providing” is performed, consideration is paid from the data acquirer (data providing destination) to the data provider (data accumulator).

Note that in the present application, for the sake of convenience, it is described as if no consideration (fee) is paid to the transaction business operator. In reality, a portion of the consideration paid from the data providing destination to the data provider and the user is paid to the transaction business operator as a “fee”.

### <Finances of Information Distribution Service>

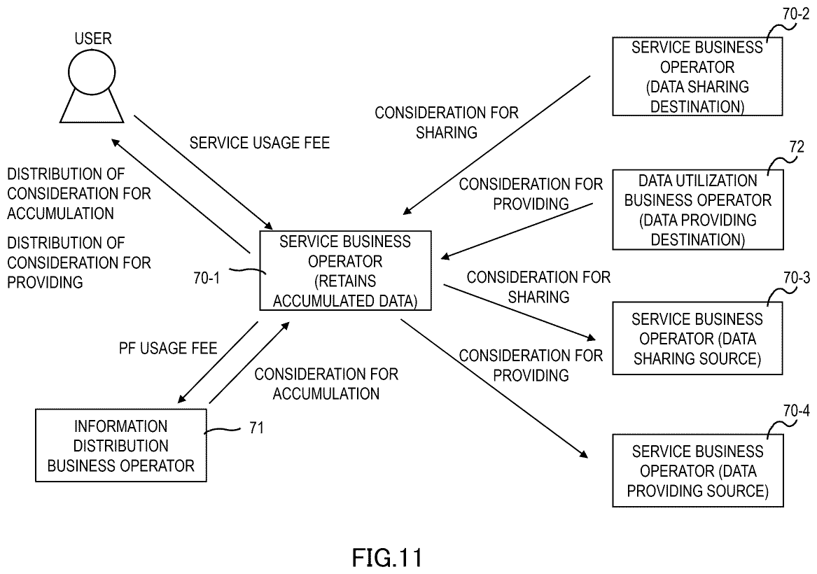

FIG. 11 is a diagram illustrating a situation related to finance of the information distribution system. FIG. 11 is a diagram illustrating a flow of money (usage fee, consideration) centered around the service business operator that retains the accumulated data (user data of the user who has consented to data utilization).

A service business operator 70-1 that retains accumulated data acquires a service usage fee from the user. Moreover, the service business operator 70-1 distributes the consideration for “accumulation” to the user who has consented to accumulate data, and distributes the consideration for “providing” to the user who has consented to provide data.

The service business operator 70-1 pays a platform (PF; Platform) usage fee to an information distribution business operator 71. Moreover, the service business operator 70-1 acquires the consideration for the “accumulation” from the information distribution business operator.

When the service business operator 70-1 provides the accumulated data to other service business operators by data sharing, the service business operator 70-1 acquires consideration for “sharing” from a service business operator 70-2 of the data sharing destination.

Similarly, when the service business operator 70-1 provides the data utilization business operator with the accumulated data by providing data, the service business operator 70-1 acquires consideration for “providing” from a data utilization business operator 72 which is a data providing destination.

When the service business operator 70-1 acquires the accumulated data from other service business operators by data sharing, the service business operator 70-1 pays consideration for “sharing” to a service business operator 70-3 which is a data sharing source.

Similarly, when the service business operator 70-1, as the data utilization business operator, acquires the accumulated data from other service business operators by providing, the service business operator 70-1 pays consideration for “providing” to a service business operator 70-4 which is a data provider.

### <Transmission of Transaction History>

When the service business operator performs data accumulation (transmits location information), the service business operator stores a history of the data accumulation (data accumulation history). Moreover, when the service business operator performs data distribution (data sharing or data providing), the service business operator stores the history related to the data distribution (data sharing history, data providing history).

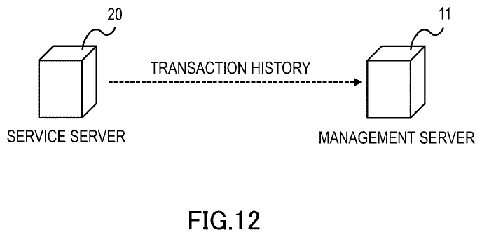

The service server 20 transmits the above history (data accumulation history, data sharing history, and data providing history) to the information distribution business operator (the management server 11) periodically or at a predetermined timing. For example, the service server 20 transmits the above transaction history to the management server 11 every predetermined period (see FIG. 12). For example, the service server 20 transmits the transaction history to the management server 11 at the end of the month.

In this way, the service business operator (the service server 20) reports the transaction history in data transactions to the information distribution business operator. Specifically, the service server 20 reports details of the transaction for each of the accumulating, sharing, and providing to the information distribution business operator.

### <Payment of Consideration>

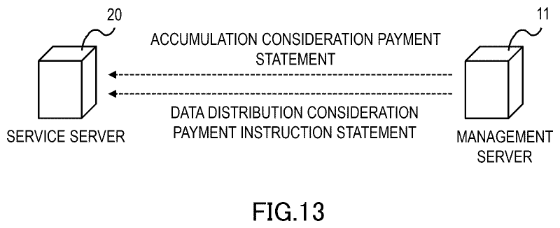

As shown in FIG. 13, the management server 11 pays consideration for accumulation to each service business operator at a predetermined timing (for example, at the beginning of each month). More specifically, after the management server 11 transmits an accumulation consideration payment statement to the service server 20, the management server 11 pays the consideration for the accumulation to the service business operator.

Furthermore, the management server 11 calculates a consideration for sharing and a consideration for providing that each service business operator (the data utilization business operator) pays to other service operators, and instructs the service operator to pay the considerations (issues a payment instruction for data distribution). Note that, in the following description, the payment instruction related to data sharing is described as a “sharing consideration payment instruction statement” and the payment instruction related to data providing is described as a “providing consideration payment instruction statement”. Further, a method of calculating the consideration for each transaction will be described below.

### <Operating Costs of Information Distribution System>

Operating an information distribution system incurs costs. The information distribution system collects platform usage fee (PF usage fee) from each of data accumulator (data holding actor), data sharing destination (sharing destination actor), and data providing destination (provided information destination actor) that retains accumulated data.

In the following, the usage fee paid by the data accumulator is referred to as “accumulation PF usage fee”, the usage fee paid by the data sharing destination is referred to as “sharing PF usage fee”, and the usage fee paid by the data providing destination is referred to as “providing PF usage fee”. The information distribution business operator covers the costs of operating the system with these usage fees (accumulation PF usage fee, sharing PF usage fee, and providing PF usage fee). As described above, the information distribution business operator pays the consideration for the accumulated data to the data accumulator.

In this way, the information distribution business operator (the management server 11) charges the data accumulator the accumulation platform usage fee related to the accumulation data. The management server 11 charges the data sharing destination the sharing platform usage fee related to the data sharing. The management server 11 charges the data providing destination the platform usage fee related to the data providing.

Here, the information distribution business operator (the management server 11) retains information related to the ratio of burden borne by each actor to the operating costs. For example, the management server 11 retains a ratio such as “accumulation burden ratio:sharing burden ratio:providing burden ratio=0.2:0.4:0.4”. Or, the management server 11 retains a ratio such as “accumulation burden ratio:sharing burden ratio:providing burden ratio=0.1:0.2:0.7”.

Note that the accumulation burden ratio is the ratio that each data accumulator that participates in the information distribution system bears the operating costs. The sharing burden ratio is the ratio that each data sharing destination that participates in the information distribution system bears the operating costs. The providing burden ratio is the ratio that each data providing destination that participates in the information distribution system bears the operating costs.

The above example of “accumulation burden ratio:sharing burden ratio:providing burden ratio=0.2:0.4:0.4” indicates that the data accumulator bears 20% of the operating costs, and the data sharing destination and the data providing destination bear 40% of the operating costs, respectively.

The management server 11 calculates the PF usage fee to be charged to the service business operators (each actor) using the ratio of each burden for the above operating costs. The management server 11 calculates the accumulation PF usage fee based on the number of cases in which the data accumulator has performed the data accumulation and the accumulation burden ratio, which defines the burden ratio of data accumulation. The management server 11 calculates the sharing PF usage fee based on the number of cases in which the data sharing destination has performed the data sharing and the sharing burden ratio, which defines the burden ratio of data sharing. The management server 11 calculates the providing PF usage fee based on the number of cases in which the data providing destination has performed the data providing and the providing burden ratio, which defines the burden ratio of the data providing. Note that a more specific method of calculating the PF usage fee will be described below.

The management server 11 bills each service business operator for the calculated PF usage fees (issues an invoice for the PF usage fee). Note that in the following description, the invoice for the PF usage fees will be described as the “PF usage fee invoice”. And, the calculation method of the PF usage fees will be described below.

<Calculation of burden ratio>

The management server 11 calculates the burden ratios (the accumulation burden ratio, the sharing burden ratio, and the providing burden ratio) based on income and expenditures of each service business operator. The calculation of the burden ratios is performed every predetermined period. For example, the management server 11 recalculates the burden ratios applied to the calculation of the PF usage fee every six months (in the first and second half of the year).

At that time, the management server 11 calculates the burden ratios so that profit of the information distribution system as a whole is improved. For example, since the source of the profit in the information distribution system is the accumulated data, the management server 11 may calculate the burden ratio so as to give preferential treatment to the data accumulator (for example, lowering the accumulation burden ratio).

In this way, the management server 11 determines the accumulation burden ratio, the sharing burden ratio, and the providing burden ratio based on income and expenditures of the data accumulator, the data sharing destination, and the data providing destination respectively. At that time, the management server 11 may determine the accumulation burden ratio, the sharing burden ratio, and the providing burden ratio o as to give a preferential treatment to the data accumulator.

### <Disclosure of Burden Ratio>

The information distribution business operator (the management server 11) discloses the calculated burden ratio. Each service business operator (each actor) uses the disclosed burden ratios and considers a cost burden, and plans a strategy for the next period (next fiscal year), and so on.

In this way, the management server 11 periodically recalculates the accumulation burden ratio, the sharing burden ratio, and the providing burden ratio. The management server 11 discloses the recalculated accumulation burden ratio, sharing burden ratio and providing burden ratio to the data accumulator, the data sharing destination and the data providing destination.

Next, details of the individual apparatuses included in the information distribution system according to the first example embodiment will be described.

### [Distribution Control Server]

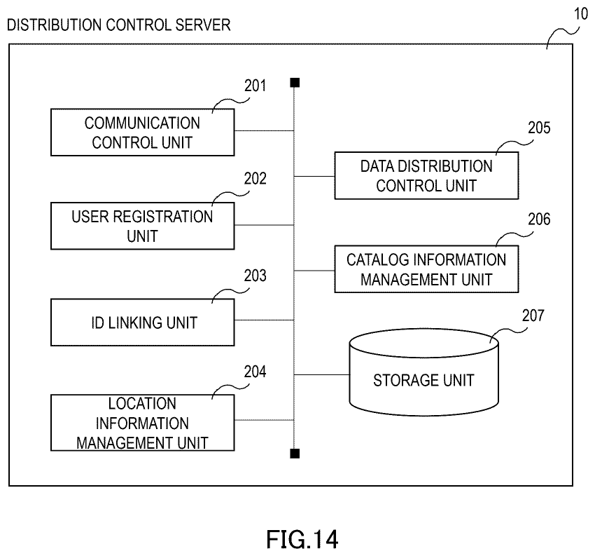

FIG. 14 is a diagram illustrating an example of a processing configuration (processing modules) of the distribution control server 10 according to the first example embodiment. Referring to FIG. 14, the distribution control server 10 includes a communication control unit 201, a user registration unit 202, an ID linking unit 203, a location information management unit 204, a data distribution control unit 205, a catalog information management unit 206, and a storage unit 207.

The communication control unit 201 is means for controlling communication with other apparatuses. Specifically, the communication control unit 201 receives data (packets) from the service server 20. In addition, the communication control unit 201 transmits data to the service server 20. The communication control unit 201 gives data received from other apparatuses to other processing modules. The communication control unit 201 transmits data acquired from other processing modules to other apparatuses. In this way, other processing modules transmit and receive data to and from other apparatuses via the communication control unit 201. The communication control unit 201 includes a function as a receiving unit that receives data from other apparatuses and a function as a transmitting unit that transmits data to other apparatuses.

The user registration unit 202 is means for realizing the above-mentioned user registration (system registration of user in the system). The user registration unit 202 acquires personal information (name, date of birth, contact information, account information, and so on) from the terminal 50 of the user.

When the user registration unit 202 acquires the personal information, the user registration unit 202 generates a user ID for identifying the user. For example, the user registration unit 202 assigns a unique value each time a user registers with the system, and uses the assigned value as the user ID.

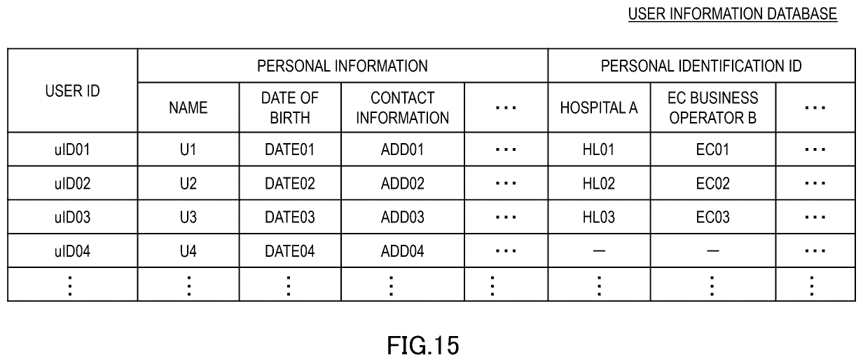

The user registration unit 202 stores the user ID and personal information in the user information database (see FIG. 15). Note that, as shown in FIG. 15, the user information database stores the user ID, personal information, and personal identification ID for each service business operator in association with each other. The user information database shown in FIG. 15 is an example and is not intended to limit the items to be stored. For example, the date and time, and so on of the user registration may be registered in the user information database.

The user registration unit 202 transmits the generated user ID to the terminal 50.

The ID linking unit 203 is means for realizing the ID linking described above. The ID linking unit 203 receives an “ID linking request” from a terminal of the service business operator (for example, the hospital terminal 60) or the service server 20. The ID linking request includes personal identifying information, personal identification ID and business operator code of a user who wishes to link the IDs (registration with the service business operator).

The ID linking unit 203 searches the user information database using personal identifying information (name of the user, combination of name and date of birth, and so on) as a key, and identifies the corresponding user. The ID linking unit 203 sets the personal identification ID included in the ID linking request in the field corresponding to the business operator code among the field of the personal identification ID of the identified user. In other words, the ID linking unit 203 identifies the user registered in the system account from the personal identifying information, and corresponds the service business operator and the personal identification ID in the account of the identified user.

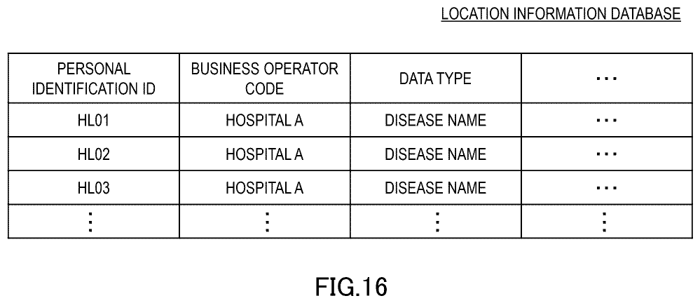

The location information management unit 204 is means for managing location information to be acquired from the service business operator. The location information management unit 204 stores the location information acquired from each of the service servers 20 in the location information database (see FIG. 16). As shown in FIG. 16, the location information database stores the personal identification ID, business operator code, and data type in association with each other.

Note that the location information database shown in FIG. 16 is an example, and is not intended to limit items to be stored. For example, the date and time, and so on, when the location information has been registered may be registered in the location information database. Moreover, in the drawings that include FIG. 16, the business operator codes are indicated by using the names of the service business operators for the sake of ease of understanding.

The data distribution control unit 205 is means for controlling data distribution by “sharing” or “providing”.

At first, data distribution related to “sharing” will be described.

The data distribution control unit 205 receives a request for sharing from the service server 20. The request for sharing includes personal identification ID of a user who is a target of data acquisition, business operator code of a sender of the request for sharing, and data type that is desired to be acquired. In the example in FIG. 7, the personal identification ID generated by EC business operator B (the service server 20-2) for user U1, the business operator code of EC business operator B, and “disease name” as the data type are included in the request for sharing.

The data distribution control unit 205 identifies a target person for data distribution based on the personal identification ID and the business operator code included in the request for sharing. Specifically, the data distribution control unit 205 refers to the user information database shown in FIG. 15 to identify the target person. In the above example, when the data distribution control unit 205 receives a request for sharing that includes the personal identification ID of “EC01” from EC business operator B, the data distribution control unit 205 grasps that user U1 is the target person for data distribution from the entry in the first row shown in FIG. 15.

After that, the data distribution control unit 205 identifies the service business operator that accumulates necessary data using the identified personal identification ID of the user and the data type included in the request for sharing. Specifically, the data distribution control unit 205 refers to the location information database shown in FIG. 16 and identifies the service business operator that accumulates data corresponding to the data type included in the request for sharing. In the example above, Hospital A is identified based on the personal identification ID “HL01” of user U1 and the data type “disease name” included in the request for sharing.

Note that when a combination of the personal identification ID of the user and the data type included in the request for sharing is not stored in the location information database, the data distribution control unit 205 transmits a negative response indicating that the data sharing is not possible to the sender of the request for sharing. In the above example, when the combination of the personal identification ID “HL01” of user U1 and the data type “disease name” is not registered in the location information database, the negative response is transmitted to EC business operator B (the service server 20-2).

Once the target person for data distribution and the data accumulator of the data to be distributed have been identified, the data distribution control unit 205 makes an inquiry for data sharing to the target person for data distribution. Specifically, the data distribution control unit 205 transmits the inquiry for the data sharing to contact information for the target person for data distribution. In the above example, the above inquiry is transmitted to the terminal 50 possessed by user U1.

Note that the inquiry for data sharing includes information such as the source of the request for sharing data, the data accumulator, and the type of data to be shared. In the above example, EC business operator B is set as the source of the request for sharing data, Hospital A as the data accumulator, and “disease name” as the data type to be shared, respectively.

The data distribution control unit 205 receives a response to the inquiry for data sharing from the terminal 50.

When the user refuses to share the data, the data distribution control unit 205 notifies the source of the request for sharing data that the data sharing is not possible. In the above example, the data distribution control unit 205 transmits a negative response to the request for sharing to the service server 20-2 of EC business operator B.

When the user has consented to share the data, the data distribution control unit 205 transmits a sharing instruction to the data accumulator. In the above example, the sharing instruction is transmitted to the service server 20-1 of Hospital A, which is the data accumulator.

The sharing instruction includes the personal identification ID generated by the data accumulator, information about the data sharing destination, and the data type of the target data to be shared. In the above example, the sharing instruction that includes the personal identification ID “HL01” of user U1, the address of the service server 20-2 of EC business operator B, and the data type “disease name” is transmitted to the service server 20-1 of Hospital A.

In this way, the data distribution control unit 205 transmits the sharing instruction that includes the personal identification ID, the personal ID being generated by the data accumulator, of the user (target person) who has consented to data sharing.

Next, data distribution related to “providing” will be described.

The data distribution control unit 205 receives a request for providing and a list of account holders from the transaction server 40.

The data distribution control unit 205 identifies catalog information that is requested to be provided from a name of a dataset that is included in the request for providing.

The data distribution control unit 205 refers to the location information database and identifies a personal identification ID corresponding to a data type and business operator code included in the identified catalog information. In the example in FIG. 10, the personal identification IDs “HL01” through “HL03” corresponding to users U1 through U3, respectively, are identified.

The data distribution control unit 205 identifies the user corresponding to the above identified user identification ID and described in the list of account holders. The data distribution control unit 205 refers to the user information database and identifies each user (at least one or more target persons for data distribution) who corresponds to the above identified user identification ID and who is described in the list of account holders.

Once the target person for data distribution has been identified, the data distribution control unit 205 makes an inquiry to the target person for data distribution to providing data. Specifically, the data distribution control unit 205 transmits an inquiry related to data providing to the contact information of the target person for data distribution. In the above example, when each of the users U1 to U3 has opened an information account with the transaction business operator, an inquiry for providing data is transmitted to the terminal 50 possessed by each of the users.

The inquiry for providing data includes information on the source of the request for providing data, information on the data accumulator, and the data type requested to be provided. In the above example, an inquiry that includes Pharmaceutical Company C as the source of the request for providing data, Hospital A as the data accumulator, and “disease name” as the data type requested to be provided is transmitted to each terminal 50.

The data distribution control unit 205 transmits a providing instruction to the data accumulator with respect to the user whose consent has been obtained. The providing instruction includes a personal identification ID of the user who has consented to provide data, information on the data providing destination (for example, name of the business operator, business operator code, and address of the data utilization server 30), and data type of the data to be provided.

The catalog information management unit 206 is means for managing catalog information. The catalog information management unit 206 stores the catalog information created by a system administrator in the storage unit 207.

The catalog information management unit 206 receives a “catalog information transmitting request” from the transaction server 40. In response to receiving the request, the catalog information management unit 206 transmits the catalog information stored in the storage unit 207 to the transaction server 40.

The storage unit 207 stores information necessary for the operations of the distribution control server 10. The user information database is established in the storage unit 207. In addition, a database or the like is constructed in the storage unit 207 to store a name of the service business operator in association with each other and a business operator code.

### [Service Server]

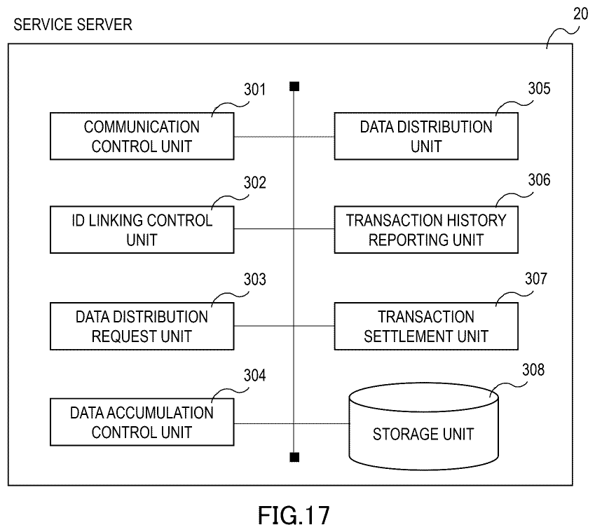

FIG. 17 is a diagram illustrating an example of a processing configuration (processing modules) of a service server 20 according to the first example embodiment. Referring to FIG. 17, the service server 20 includes a communication control unit 301, an ID linking control unit 302, a data distribution request unit 303, a data accumulation control unit 304, a data distribution unit 305, a transaction history reporting unit 306, a transaction settlement unit 307, and a storage unit 308.

The communication control unit 301 is means for controlling communication with other apparatuses. For example, the communication control unit 301 receives data (packets) from the distribution control server 10. In addition, the communication control unit 301 transmits data to the distribution control server 10. The communication control unit 301 gives data received from other apparatuses to other processing modules. The communication control unit 301 transmits data acquired from other processing modules to other apparatuses. In this way, other processing modules transmit and receive data to and from other apparatuses via the communication control unit 301. The communication control unit 301 includes a function as a receiving unit that receives data from other apparatuses and a function as a transmitting unit that transmits data to other apparatuses.

The ID linking control unit 302 is means for performing control related to ID linking of a user. The ID linking control unit 302 acquires a request for the ID linking from the user who has logged in to an account using a GUI (Graphical User Interface) or the like. In response to the request from the user, the ID linking control unit 302 transmits to the distribution control server 10 an “ID linking request” that includes personal identifying information (such as name of the user who has logged in), personal identification ID (such as membership ID of the user), and business operator code.

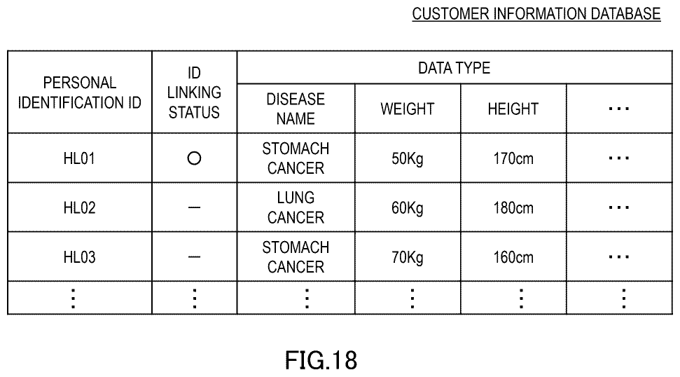

Note that the personal identification ID, personal identifying information, and user data, and so on, of the user are managed using the customer information database (see FIG. 18). As shown in FIG. 18, the customer information database retains information (flags) on whether or not ID linking of the user has been completed. When the ID linking control unit 302 has completed the ID linking, the ID linking control unit 302 sets a flag in the ID linking status field of the corresponding user (in FIG. 18, the flag is set to “O”).

The data distribution request unit 303 is means for requesting data distribution (data sharing) related to the data of a user to the information distribution business operator. The data distribution request unit 303 transmits a request for sharing to the distribution control server 10 in response to an operation by a staff member, and so on of the service business operator. Specifically, the data distribution request unit 303 transmits the request for sharing that includes a personal identification ID of the user who is a target for data acquisition, a business operator code of own apparatus, and a data type that the user wishes to acquire to the distribution control server 10.

The data accumulation control unit 304 is means for performing control related to accumulation of user data resulting from providing a service to a user. The data accumulation control unit 304 stores a personal identification ID of the user in association with each other and the user data (data generated as a result of providing the service to the user or data necessary for providing the service to the user) in the customer information database.

As shown in FIG. 18, the data accumulation control unit 304 stores the user data in a field corresponding to the data type generated (stores specific data contents). Note that FIG. 18 shows a diagram illustrating an example of the customer information database established on the service server 20-1 of Hospital A.

Here, with respect to the user for whom the ID linking has been completed, the data accumulation control unit 304 transmits location information to the distribution control server 10 each time the data accumulation control unit 304 stores the user data in the customer information database. For example, when a service is provided to a user with the personal identification ID “HL01” and data on a disease name is generated as a result of medical examination, the location information that includes the personal identification ID “HL01”, the business operator code “Hospital A”, and the data type “disease name” is transmitted to the distribution control server 10.

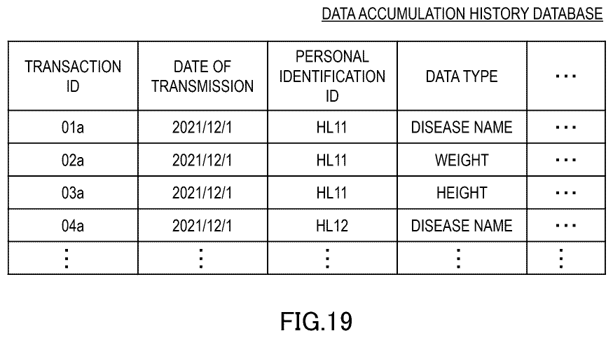

The data accumulation control unit 304 stores a history of transmission of the location information in a data accumulation history database (see FIG. 19). As shown in FIG. 19, the data accumulation history database stores the date of transmission of the location information, the personal identification ID notified by the location information, and the data type, and so on, in association with each other. Note that FIG. 19 illustrates an example of the data accumulation history database established in the service server 20-1 of Hospital A.

The data distribution unit 305 is means for realizing data distribution by “sharing” or “providing”. The data distribution unit 305 processes “sharing instruction” or “providing instruction” received from the distribution control server 10.

When the data distribution unit 305 receives a sharing instruction, the data distribution unit 305 refers to the customer information database and identifies an entry that corresponds to the personal identification ID and the data type included in the sharing instruction. For example, when the data distribution unit 305 receives the sharing instruction that includes the personal identification ID “HL01” and the data type “disease name”, the data distribution unit 305 identifies the entry shown in the top row of FIG. 18.

The data distribution unit 305 transmits the user data described in the data type field corresponding to the identified entry to the data sharing destination designated in the sharing instruction. In the example in FIG. 7, “stomach cancer” is transmitted to the service server 20-2 of EC business operator B.

The data distribution unit 305 processes the providing instruction in the same manner as the sharing instruction. The data distribution unit 305 transmits the user data determined by the personal identification ID and the data type included in the providing instruction to the data providing destination designated by the providing instruction.

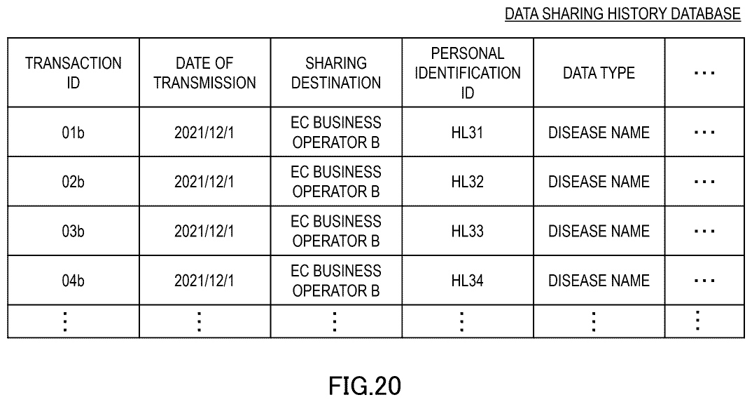

Each time the data distribution unit 305 processes the sharing or providing instruction, the data distribution unit 305 stores a history of the data distribution transaction. Specifically, when the data distribution unit 305 processes the sharing instruction, the data distribution unit 305 stores details of the data sharing in the data sharing history database shown in FIG. 20. FIG. 20 illustrates an example of the data sharing history database established on the service server 20-1 of Hospital A.

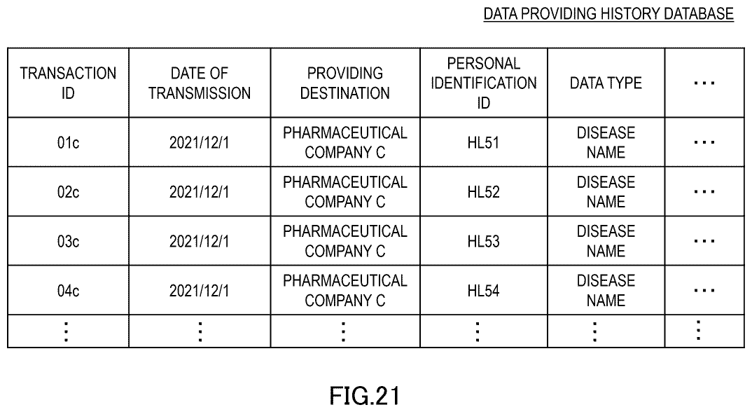

After the data distribution unit 305 processes the providing instruction, the data distribution unit 305 stores details of the data providing in the data providing history database shown in FIG. 21. FIG. 21 illustrates an example of the data providing history database established on the service server 20-1 of Hospital A.

The transaction history reporting unit 306 is means for reporting transaction history (data accumulation history, data sharing history, and data providing history). The transaction history reporting unit 306 transmits history information for a predetermined period to the management server 11 periodically or at a predetermined timing. For example, the transaction history reporting unit 306 transmits the history information for the current month (corresponding entries in the above three databases) to the management server 11 at the end of the month. At that time, the transaction history reporting unit 306 also notifies the management server 11 with its own business operator code.

Specifically, the transaction history reporting unit 306 refers to a date and time of transmission field of each database and identifies the entry to be transmitted (to be reported). The transaction history reporting unit 306 transmits the identified entry (at least one or more entries) and the business operator code to the management server 11.

The transaction settlement unit 307 is means for settling a transaction or the like related to data accumulation and data distribution. The transaction settlement unit 307 receives a statement of the accumulated data (an accumulation consideration payment statement) from the management server 11. The transaction settlement unit 307 calculates the consideration to be paid to each user (customer) based on the transaction details included in the statement. The transaction settlement unit 307 calculates the consideration to be paid to each user (total amount of consideration) by multiplying the consideration of the transaction details by an accumulation consideration distribution rate, and pays the consideration to each user. Note that the accumulation consideration distribution rate will be described below.

The transaction settlement unit 307 receives a statement of payment instruction related to data distribution (sharing consideration payment instruction statement, providing consideration payment instruction statement) from the management server 11. With respect to the sharing consideration payment instruction statement, the transaction settlement unit 307 calculates a consideration to be paid to each data sharing destination based on transaction details included in the instruction statement. The transaction settlement unit 307 adds up a consideration in the transaction details for each data sharing destination and calculates the consideration to be paid to each data sharing destination (total amount of consideration). The transaction settlement unit 307 pays the calculated consideration to each data sharing destination.

With respect to the providing consideration payment instruction statement, the transaction settlement unit 307 calculates a consideration to be paid to each data providing destination based on transaction details included in the instruction statement. The transaction settlement unit 307 adds up the consideration in the transaction details for each data providing destination and calculates the consideration to be paid to each data providing destination (total amount of consideration). The transaction settlement unit 307 pays the calculated consideration to each data providing destination.

Note that the transaction settlement unit 307 notifies the data providing destination of the portion of the providing consideration payment instruction statement received from the distribution control server 10 that relates to each data providing destination. The transaction settlement unit 307 of the data providing destination pays consideration to the user who consented to provide data based on the transaction details included in the notification. The transaction settlement unit 307 calculates the consideration to be paid to each user by multiplying the received providing consideration by the providing consideration distribution rate. The transaction settlement unit 307 pays the calculated consideration to the user. Note that the providing consideration distribution ratio will be described below.

When the transaction settlement unit 307 receives an invoice for PF usage fee from the management server 11, the transaction settlement unit 307 pays the PF usage fee described in the invoice (accumulation PF usage fee, sharing PF usage fee, and providing PF usage fee) to the information distribution business operator.

The storage unit 308 stores information necessary for the operations of the service server 20. For example, the storage unit 308 stores account information of each actor (service business operator, user, and information distribution business operator) in association with a business operator code, a personal identification ID, and so on.

### [Data Utilization Server]

A processing configuration of the data utilization server 30 can be the same as that of the service server 20. The data distribution request unit 303 of the data utilization server 30 may present information to a user (a staff member of the data utilization business operator) and accepts an operation from the user. Specifically, the data distribution request unit 303 may display a list of catalog information, and so on, obtained from the transaction server 40, and transmit to the transaction server 40 a request for providing that includes a dataset name and search conditions of the catalog information selected by the user.

Furthermore, the transaction settlement unit 307 of the data utilization server 30 may pay a portion of a consideration paid to the data providing destination to the transaction business operator.

### [Transaction Server]

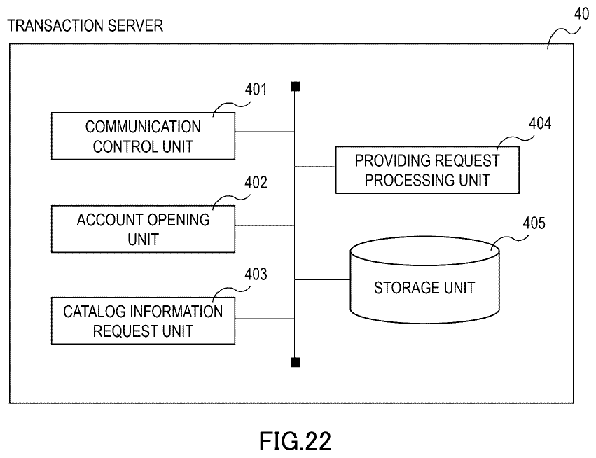

FIG. 22 is a diagram illustrating an example of a processing configuration (processing module) of the transaction server 40 according to the first example embodiment. Referring to FIG. 22, the transaction server 40 includes a communication control unit 401, an account opening unit 402, a catalog information request unit 403, a providing request processing unit 404, and a storage unit 405.

The communication control unit 401 is means for controlling communication with other apparatuses. For example, the communication control unit 401 receives data (packets) from the distribution control server 10. In addition, the communication control unit 401 transmits data to the distribution control server 10. The communication control unit 401 gives data received from other apparatuses to other processing modules. The communication control unit 401 transmits data acquired from other processing modules to other apparatuses. In this way, other processing modules transmit and receive data to and from other apparatuses via the communication control unit 401. The communication control unit 401 includes a function as a receiving unit that receives data from other apparatuses and a function as a transmitting unit that transmits data to other apparatuses.

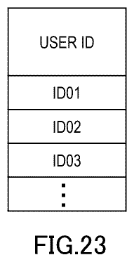

The account opening unit 402 is means for opening an account for a user who wishes to distribute data by providing. The account opening unit 402 acquires a user ID from the terminal 50 of the user. The account opening unit 402 adds the acquired user ID to a list of account holders (see FIG. 23).

The catalog information request unit 403 is means for transmitting a “catalog information request” to the distribution control server 10.

When the catalog information request unit 403 receives a “catalog information presentation request” from the data utilization server 30, the catalog information request unit 403 transmits a “catalog information transmission request” to the distribution control server 10.

In response to transmitting the request, the catalog information request unit 403 acquires the catalog information stored by the distribution control server 10. The catalog information request unit 403 selects catalog information relating to the service business operator with which own apparatus has a partnership and transmits catalog information to the data utilization business operator (the data utilization server 30). Note that the catalog information request unit 403 selects catalog information related to the partnered service business operator based on the business operator code of the partnered service business operator and the business operator code included in the catalog information.

The providing request processing unit 404 is means for processing a request for providing received from the data utilization server 30. The providing request processing unit 404 examines search conditions included in the request for providing. Specifically, the providing request processing unit 404 performs an examination of the consistency between a purpose of data utilization by the data utilization business operator and a purpose of use of a target data type. For example, if the content is “Purpose of use: development of a new drug, data type: disease name”, the examination will be passed. In other words, the data utilization business operator (the data utilization server 30) also enters the above purpose of use and data type into the transaction server 40 when the data utilization business operator requests to provide data.

When the examination is passed, the providing request processing unit 404 transmits the list of account holders along with the acquired request for providing from the data utilization server 30 to the distribution control server 10.

The storage unit 405 stores information necessary for the operations of the transaction server 40. The storage unit 405 stores the business operator code of the partnered service business operator.

### [Terminal]

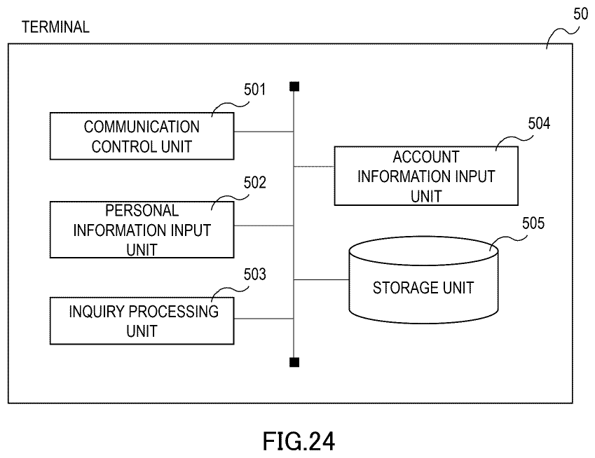

FIG. 24 is a diagram illustrating an example of a processing configuration (processing modules) of the terminal 50 according to the first example embodiment. Referring to FIG. 24, the terminal 50 includes a communication control unit 501, a personal information input unit 502, an inquiry processing unit 503, an account information input unit 504, and a storage unit 505.

The communication control unit 501 is means for controlling communication with other apparatuses. For example, the communication control unit 501 receives data (packets) from the distribution control server 10. In addition, the communication control unit 501 transmits data to the distribution control server 10. The communication control unit 501 gives data received from other apparatuses to other processing modules. The communication control unit 501 transmits data acquired from other processing modules to other apparatuses. In this way, other processing modules transmit and receive data to and from other apparatuses via the communication control unit 501. The communication control unit 501 includes a function as a receiving unit that receives data from other apparatuses and a function as a transmitting unit that transmits data to other apparatuses.

The personal information input unit 502 is means for inputting personal information to the distribution control server 10 at the time of user registration. The personal information input unit 502 inputs the personal information (name, date of birth, contact information, account information, and so on) to the distribution control server 10 using any means. For example, the personal information input unit 502 acquires the above personal information from the user using a GUI and transmits the acquired personal information to the distribution control server 10.

The personal information input unit 502 stores a user ID issued by the distribution control server 10 in the storage unit 505.

The inquiry processing unit 503 is means for processing an inquiry received from the distribution control server 10 at the time of data distribution by sharing or at the time of data distribution by providing. The inquiry processing unit 503 acquires an intention of the user (consent or non-consent to data distribution) using a GUI tailored to the content of the inquiry (data sharing or data providing). The inquiry processing unit 503 transmits a response that includes the intention of the user to the distribution control server 10.

The account information input unit 504 is means for inputting information for opening an information account to the transaction server 40, which is required at the time of data distribution by providing. The account information input unit 504 transmits a user ID of the user to the transaction server 40.

The storage unit 505 stores information necessary for the operations of the terminal 50.

### [Hospital Terminal]

Examples of the hospital terminal 60 include mobile terminal device such as a smartphone, tablet, and so on, or a computer (personal computer, laptop), and so on. The hospital terminal 60 can be any equipment or device as long as the hospital terminal 60 can accept an operation by a hospital staff member and can communicate with the distribution control server 10, or the like. Further, since the configuration, and so on, of the hospital terminal 60 is obvious to those skilled in the art, a detailed description will be omitted.

The hospital terminal 60 may transmit an ID linking request to the distribution control server 10 in response to the operation by the hospital staff member. Moreover, the hospital terminal 60 also transmits the ID linking request to its own service server 20. The service server 20 (the ID linking control unit 302) sets a flag in the ID linking status field of the entry of the user (entry in the customer information database) corresponding to a personal identification ID included in the ID linking request.

### [Management Server]

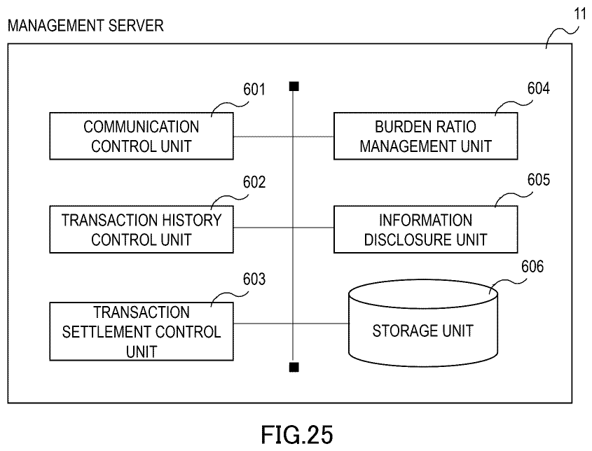

FIG. 25 is a diagram illustrating an example of a processing configuration (processing modules) of the management server 11 according to the first example embodiment. Referring to FIG. 25, the management server 11 includes a communication control unit 601, a transaction history control unit 602, a transaction settlement control unit 603, a burden ratio management unit 604, an information disclosure unit 605, and a storage unit 606.

The communication control unit 601 is means for controlling communication with other apparatuses. Specifically, the communication control unit 601 receives data (packets) from the service server 20. In addition, the communication control unit 601 transmits data to the service server 20. The communication control unit 601 gives data received from other apparatuses to other processing modules. The communication control unit 601 transmits data acquired from other processing modules to other apparatuses. In this way, other processing modules transmit and receive data to and from other apparatuses via the communication control unit 601. The communication control unit 601 includes a function as a receiving unit that receives data from other apparatuses and a function as a transmitting unit that transmits data to other apparatuses.

The transaction history control unit 602 is means for performing control related to a history of a transaction performed in the information distribution system. The transaction history control unit 602 stores history information (data accumulation history, data sharing history, and data providing history) received from the service server 20 in a database.

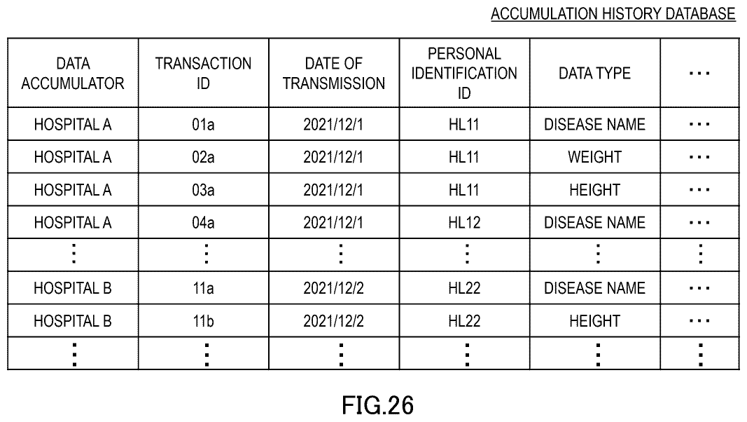

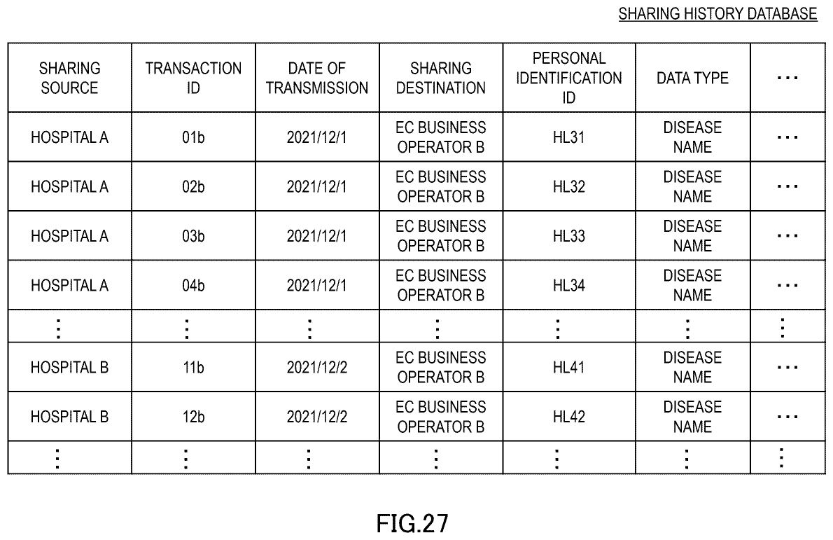

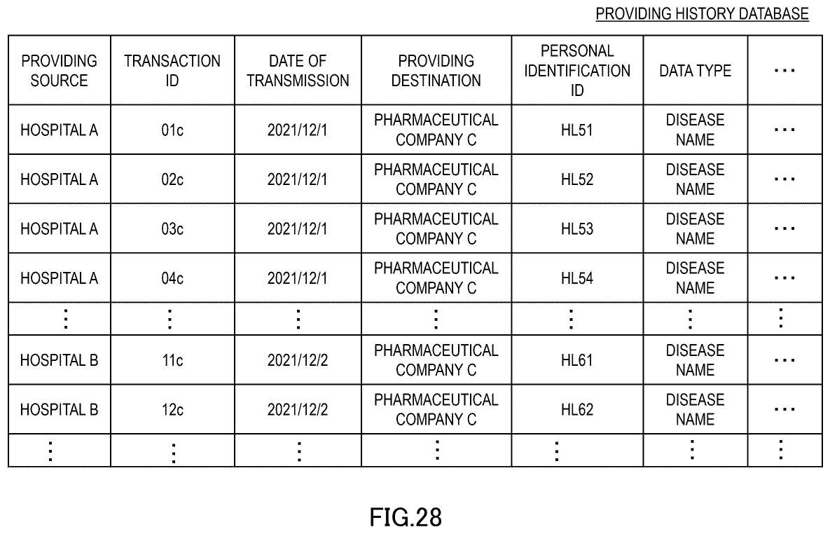

Specifically, the transaction history control unit 602 stores the data accumulation history in the accumulation history database, the data sharing history in the sharing history database, and the data providing history in the providing history database (see FIGS. 26, 27 and 28). At that time, the transaction history control unit 602 stores a business operator code of a sender of the history information (data accumulator, source of data sharing, source of data providing) in each database.

The transaction settlement control unit 603 is means for performing control related to settlement of a transaction that has occurred in the information distribution system. For example, the transaction settlement control unit 603 calculates a consideration to be received by each service business operator at a predetermined timing (for example, at the beginning of the month).

### <Calculation of Consideration for Accumulation>

The transaction settlement control unit 603 refers to the accumulation history database and calculates consideration for accumulation for each entry that belongs to a period subject to consideration payment (for example, one month). In the example of the first line shown in FIG. 26, the consideration is calculated for Hospital A accumulating data on the “disease name” of a user corresponding to the personal identification ID “HL11”. The transaction settlement control unit 603 calculates the consideration for each data accumulator by adding up, per the data accumulator, the consideration calculated per each entry for the period subject to consideration payment (for example, one month).

The consideration for accumulating data is calculated using Formula (1). As shown in Formula (1), the consideration for accumulation is determined by an accumulation price of a dataset and the number of new transactions. “i” is an index indicating the dataset. “j” is an index indicating a user involved in the accumulation.

$$\begin{matrix}[ Formula ( 1 ) ] & \\ [ consideration for accumulation ] = \sum ( [ accumulation price ( i ) ] \times [ number of new transactions ( i ) ] & ( 1 )\end{matrix}$$

The transaction settlement control unit 603 calculates the accumulation price using the calculation formula shown in Formula (2) below. As shown in Formula (2), the accumulation price is determined by a data price, a sharing demand coefficient, and a providing demand coefficient. The sharing demand coefficient and providing demand coefficient are coefficients that indicate the strength of demand with respect to sharing and providing, respectively. Usually, the demand for “disease name” is stronger than that for “weight” or “height”, and the sharing demand coefficient and providing demand coefficient for “disease name” are set higher than the coefficients for “weight” and the like.

$$\begin{matrix}[ Formula ( 2 ) ] & \\ [ accumulation price ( i ) ] = [ data price ( i ) ] \times [ sharing demand coefficient ( i ) ] \times [ providing demand coefficient ( i ) ] & ( 2 )\end{matrix}$$

The transaction settlement control unit 603 calculates the data price using the calculation formula shown in Formula (3) below. As shown in Formula (3), the data price is determined by a valuation amount of the dataset and a holding source coefficient. The holding source coefficient is a parameter that can be freely determined by the service business operator that accumulates the data. Each service business operator sets the holding source coefficient taking into account its own idea of “accumulation”. The holding source coefficient is notified by each service business operator to the information distribution business operator (the management server 11).

$$\begin{matrix}[ Formula ( 3 ) ] & \\ [ data price ( i ) ] = [ valuation amount ( i ) ] \times [ holding source coefficient ] & ( 3 )\end{matrix}$$

The transaction settlement control unit 603 calculates the valuation amount using the calculation formula shown in Formula (4) below. As shown in Formula (4), the valuation amount is determined by a reference price and an accuracy coefficient. The reference price is determined by the information distribution business operator with reference to a degree of difficulty and management cost, and so on, in generating the dataset. For example, since diagnosing a disease is more difficult than measuring weight, height, and so on, the reference price for “disease name” is set higher than that for “weight” and so on. An accuracy coefficient is determined by an accuracy that each data set has compared to other datasets in the same category. For example, the accuracy coefficient is determined by the accuracy of each data in various measurement data such as “weight”, “height”, “blood pressure”, and “heart rate”. For example, the accuracy coefficient for “blood pressure” is set low because “blood pressure” is greatly influenced by the conditions at the time of measurement. Note that “I” in Formula (4) is an index indicating a category.

$$\begin{matrix}[ Formula ( 4 ) ] & \\ [ valuation amount ( i ) ] = [ reference price ( I ) ] \times [ accuracy coefficient ( i ) ] & ( 4 )\end{matrix}$$

In this way, the accumulation consideration is calculated according to the parameter determined by the information distribution business operator and the parameter determined by the service business operator.

### <Calculation of Consideration for Sharing>

The transaction settlement control unit 603 refers to the sharing history database and calculates consideration for sharing for each entry that belongs to a period subject to consideration payment (for example, one month). The transaction settlement control unit 603 calculates consideration for each data sharing source by adding up the consideration calculated for each entry in the period subject to consideration payment per each data sharing source.

The consideration for sharing is calculated using the calculation formulas shown in Formulas (5) and (6) below. Formula (5) shows the consideration acquired by sharing, and Formula (6) shows the consideration paid for sharing. As shown in Formulas (5) and (6), the consideration for sharing is determined by a sharing price and the number of transactions. Note that “k” is an index indicating a trading partner in the data distribution.

$$\begin{matrix}[ Formula ( 5 ) ] & \\ [ consideration for sharing ] = \sum ( [ sharing price ( i ) ] \times [ number of sharing cases ( k ) ] & ( 5 )\end{matrix}$$

$$\begin{matrix}[ Formula ( 6 ) ] & \\ [ consideration for sharing ] = \sum ( [ sharing price ( i ) ] \times [ number of shared cases ( k ) ] & ( 6 )\end{matrix}$$

The transaction settlement control unit 603 calculates the sharing price using the calculation formula shown in Formula (7) below. As shown in Formula (7), the sharing price is determined by the data price, the sharing demand coefficient, and the sharing source coefficient. Among these three parameters, the sharing source coefficient is a parameter that can be freely determined by the data sharing source (the service business operator that retains the accumulated data). For example, the data sharing source that wishes to keep the sharing price low and realize a large number of transactions sets the sharing source coefficient low. The service business operator determines the sharing source coefficient and notifies the information distribution business operator.

$$\begin{matrix}[ Forrmula ( 7 ) ] & \\ [ sharing price ( i \vert k ) ] = [ data price ( i \vert k ) ] \times [ sharing demand coefficient ( i \vert k ) ] \times [ sharing source coefficient ( i \vert k ) ] & ( 7 )\end{matrix}$$

### <Calculation of Consideration for Providing>

The transaction settlement control unit 603 refers to the providing history database and calculates consideration for providing for each entry that belongs to a period subject to consideration payment (for example, one month). The transaction settlement control unit 603 calculates consideration for each data provider by adding up the consideration calculated for each entry in the period subject to consideration payment per each data provider.

The consideration for providing is calculated by the calculation formulas shown in Formulas (8) and (9) below. Formula (8) shows the consideration acquired by providing, and Formula (9) shows the consideration paid by providing. As shown in Formulas (8) and (9), the consideration for providing is determined by a providing price and the number of transactions.

$$\begin{matrix}[ Formula ( 8 ) ] & \\ [ consideration for providing ] = \sum ( [ providing price ( i ) ] \times [ number of providing cases ( k ) ] & ( 8 )\end{matrix}$$

$$\begin{matrix}[ Formula ( 9 ) ] & \\ [ consideration for providing ] = \sum ( [ providing price ( i ) ] \times [ number of provided cases ( k ) ] & ( 9 )\end{matrix}$$

The transaction settlement control unit 603 calculates the providing price using the calculation formula shown in Formula (10) below. As shown in Formula (10), the providing price is determined by a data price, a providing demand coefficient, and a provider coefficient. Among these three parameters, the provider coefficient is a parameter that can be freely determined by the data provider (the service business operator that retains the accumulated data). The service business operator determines the provider coefficient and notifies the information distribution business operator.

$$\begin{matrix}[ Forrmula ( 10 ) ] & \\ [ providing price ( i \vert k ) ] = [ data price ( i \vert k ) ] \times [ providing demand coefficient ( i \vert k ) ] \times [ provider coefficient ( i \vert k ) ] & ( 10 )\end{matrix}$$

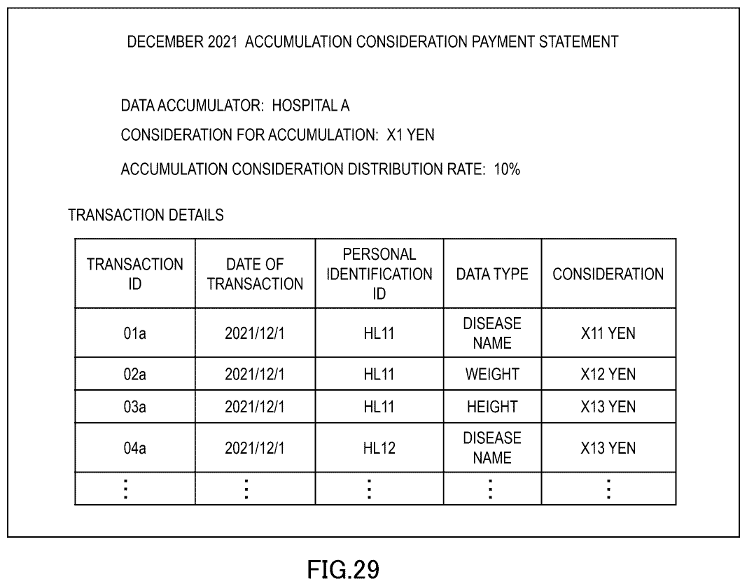

The transaction settlement control unit 603 creates a payment statement for the consideration related to the accumulation paid from the information distribution business operator to the service business operator per each service business operator. For example, the transaction settlement control unit 603 creates the payment statement that includes the consideration for each transaction of data accumulation (the accumulation consideration payment statement), as shown in FIG. 29.

Note that, as described above, when data accumulation is performed, a consideration is distributed to a user involved in the data accumulation. The transaction settlement control unit 603 describes the distribution rate of the consideration (accumulation consideration distribution rate) in the payment statement. FIG. 29 shows an example in which 10% of the consideration for accumulation paid from the information distribution business operator to Hospital A is distributed to the user.

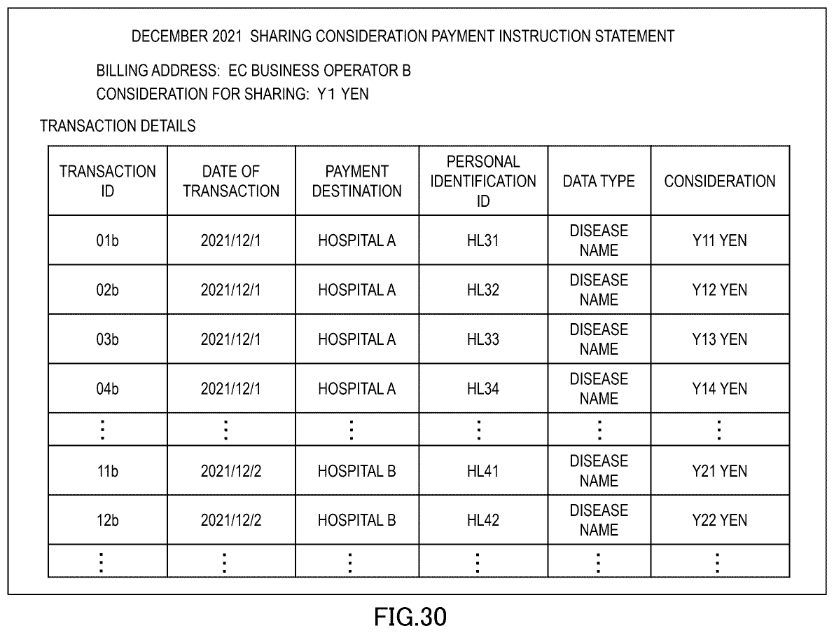

Furthermore, for each service business operator, the transaction settlement control unit 603 creates a payment instruction statement for consideration for sharing (sharing consideration payment instruction) to be paid by the service business operator to other service business operators for data sharing. For example, the transaction settlement control unit 603 creates the payment instruction statement as shown in FIG. 30.

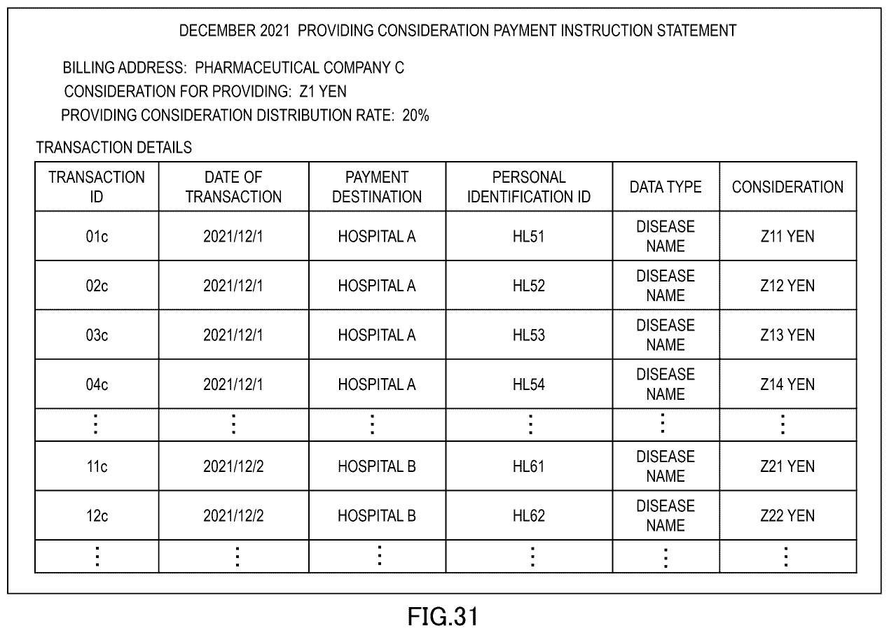

Similarly, for each service business operator, the transaction settlement control unit 603 creates a payment instruction statement for consideration (providing consideration payment instruction statement) that the service business operator pays to other service business operators for providing data. For example, the transaction settlement control unit 603 creates the payment instruction statement shown in FIG. 31.

As described above, when data is provided, a consideration for providing the data is distributed to a user involved in providing the data. The transaction settlement control unit 603 describes the distribution ratio for the consideration for providing (providing consideration distribution ratio) in the payment instruction statement. FIG. 31 shows an example in which 20% of the consideration for providing paid by a pharmaceutical company to a hospital is distributed to the user.

The transaction settlement control unit 603 transmits the generated accumulation consideration payment statement and payment instruction statement (sharing consideration payment instruction statement and providing consideration payment instruction statement) to the service server 20 of each service business operator and to the data utilization server 30 of each data utilization business operator.

In this way, the transaction history control unit 602 acquires a data accumulation history related to a transaction of data accumulation from the data accumulator. Further, the transaction settlement control unit 603 calculates a consideration for accumulation to be paid to the data accumulator based on the data accumulation history, and pays the calculated consideration for accumulation to the data accumulator.

### <Charging PF Usage Fee>

The transaction settlement control unit 603 is means for charging each service business operator for payment of a PF usage fee. The transaction settlement control unit 603 calculates the PF usage rate for each data accumulator, data sharing destination, and data providing destination during a predetermined period (period subject to consideration payment; for example, one month).

For example, when Hospital A is the data accumulator and data sharing destination, Hospital A is charged the accumulation PF usage fee and the sharing PF usage fee. In addition, when Pharmaceutical Company C does not accumulate data and is limited to use provided data, Pharmaceutical Company C is charged the providing PF usage fee.

The transaction settlement control unit 603 calculates the accumulation PF usage fee for each data accumulator using the calculation formula shown in Formula (11) below. Note that the PF cost is the cost of personnel expense, equipment expense, and so on required for operating the information distribution system. Moreover, as described above, the accumulation burden ratio, sharing burden ratio, and providing burden ratio are values that have already been determined at the time of calculating the PF usage fee.

$$\begin{matrix}[ Formula ( 11 ) ] & \\ [ accumulation PF usage fee ] = [ PF cost ] \times [ accumulation burden ratio ] \times [ number of accumulation cases / \\ total number of accumulation cases ] & ( 11 )\end{matrix}$$

In Formula (11), the total number of accumulated data is the total number of accumulated data that occurred during a predetermined period (for example, one month). For example, when 1,000 cases of accumulation occur during the above predetermined period and 10 cases of those are accumulated by Hospital A, then 1% of the amount obtained by multiplying the PF cost by the accumulation burden ratio is the accumulation PF usage fee for Hospital A.

The transaction settlement control unit 603 calculates the sharing PF usage fee for the data sharing destination using the calculation formula shown in Formula (12) below.

$$\begin{matrix}[ Formula ( 12 ) ] & \\ [ sharing PF usage fee ] = [ PF cost ] \times [ sharing burden ratio ] \times [ number of sharing cases / total number of sharing cases ] & ( 12 )\end{matrix}$$

The transaction settlement control unit 603 calculates the providing PF usage fee for the data providing destination using the calculation formula shown in Formula (13) below.

$$\begin{matrix}[ Formula ( 13 ) ] & \\ [ providing PF usage fee ] = [ PF cost ] \times [ providing burden ratio ] \times [ number of providing cases / total number of providing cases ] & ( 13 )\end{matrix}$$

In this way, the transaction settlement control unit 603 calculates the PF usage fee to be charged to the service business operator (each actor) using each burden ratio of “accumulation”, “sharing”, and “providing” to the operating cost of the information distribution system. The transaction settlement control unit 603 charges the calculated PF usage fee to each service business operator and data utilization business operator (issues a PF usage fee invoice).

For example, in the example above, since Hospital A is both the data accumulator and the data sharing destination, the transaction settlement control unit 603 charges Hospital A for the payment of the accumulation PF usage fee and the sharing PF usage fee. Similarly, the transaction settlement control unit 603 charges the providing PF usage fee to Pharmaceutical Company C.

### <Generation of Income and Expenditure Management Statement>

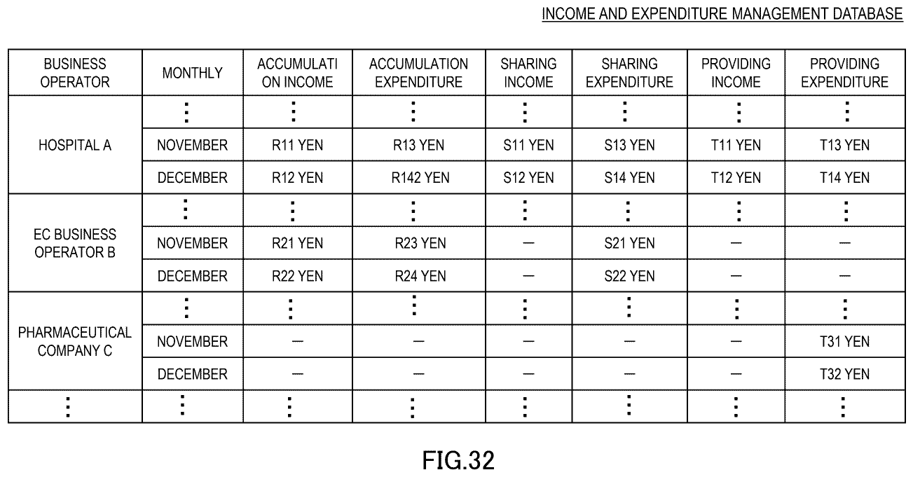

The transaction settlement control unit 603 generates an income and expenditure management statement showing income and expenditure for each actor based on the above generated accumulation consideration payment statement, sharing consideration payment instruction statement, and providing consideration payment instruction statement. Specifically, with respect to each actor, the transaction settlement control unit 603 stores the income and expenditure for each predetermined period (period subject to consideration payment) in an income and expenditure management database (see FIG. 32). The income and expenditure management database shown in FIG. 32 is a diagram illustrating an example and is not intended to limit the items to be stored.

With respect to the income and expenditure of the accumulation, the transaction settlement control unit 603 calculates an accumulation income based on the accumulation consideration to be paid to the service business operator and the accumulation consideration distribution rate. The portion of the accumulation consideration paid to the service business operator that is distributed to the service business operator is the “accumulation income”. In addition, the accumulation expenditure is the PF usage fee (accumulation PF usage fee) paid by the service business operator to the information distribution business operator.

With respect to the income and expenditure of sharing, the transaction settlement control unit 603 calculates the consideration paid for sharing to the service business operator as “sharing income”. Furthermore, the transaction settlement control unit 603 calculates the total amount of the consideration paid for sharing to other service business operators and the PF usage fee (sharing PF usage fee) paid to the information distribution business operator as “sharing expenditure” of the service business operator.

With respect to the income and expenditure of providing, the transaction settlement control unit 603 calculates the providing income based on the consideration for providing paid to the service business operator and the providing consideration distribution ratio. The portion of the consideration for providing paid to the service business operator that is distributed to the service business operator is the “providing income”. In addition, the transaction settlement control unit 603 calculates the total amount of the consideration paid to other service business operators and the PF usage fee paid to the information distribution business operator (providing PF usage fee) as “providing expenditure” of the service business operator.

### <Calculation of Burden Ratio>

The burden ratio management unit 604 is means for managing the burden ratio involved in the calculation of the PF usage fee. The burden ratio management unit 604 calculates the burden ratio (accumulation burden ratio, sharing burden ratio, and providing burden ratio) based on the income and expenditure of each service business operator. The calculation of the burden ratio is performed every predetermined period (burden ratio review period; for example, 6 months, 1 year).

Specifically, the burden ratio management unit 604 redetermines each of the above burden ratio after the above burden ratio review period has elapsed. In other words, the burden ratio management unit 604 recalculates the burden ratio to be applied to the next period (next 6 months or 1 year) every predetermined period (for example, every 6 months, 1 year).

At that time, the burden ratio management unit 604 calculates the burden ratio so that profit of the information distribution system as a whole is improved. For example, since the source of the profit in the information distribution system is the accumulated data, the burden ratio management unit 604 calculates the burden ratio so as to give preferential treatment to the data accumulator (for example, lowering the accumulation burden ratio).

For example, the burden ratio management unit 604 calculates the income and expenditure for each actor (the total amount of the income and expenditure for each of accumulation, sharing, and providing) by applying a new candidate of burden ratio to the actual results for the current period (the actual results of accumulation, sharing, and providing for each actor). After that, the burden ratio management unit 604 selects the burden ratio that will result in a surplus in the income and expenditure of as many actors as possible, and determines the three burden ratios to be applied for the next fiscal year.

At that time, when it is not possible to make the income and expenditure of all the actors into a surplus, the burden ratio management unit 604 selects the accumulation burden ratio that gives preferential treatment to the data accumulator. Note that, in this case, when one service business operator is more than one actor, such as a data accumulator, a data sharing destination, and a data providing destination, the burden ratio management unit 604 calculates the burden ratio so that the service business operator as the data accumulator has a surplus in income and expenditure.

For example, when Hospital A is both the data accumulator and the data sharing destination, the burden ratio management unit 604 determines the accumulation burden ratio so that the income and expenditure related to data accumulation of Hospital A becomes a surplus. In other words, the burden ratio management unit 604 calculates the income and expenditure of the data accumulator by subtracting the accumulation PF usage fee from the accumulation consideration paid to the data accumulator. Furthermore, the burden ratio management unit 604 recalculates the accumulation burden ratio so that the income and expenditure of the data accumulator becomes a surplus.

Note that when the data accumulator is given preferential treatment, the accumulation burden ratio is usually lower than the other burden ratios, and the sharing burden ratio and providing burden ratio are higher. When the accumulation burden ratio falls, the income and expenditure of Hospital A related to data sharing is expected to deteriorate, and the overall income and expenditure may become negative. However, it is likely that Hospital A generates revenue by utilizing data sharing, and such a deterioration in its income and expenditure is acceptable.

Alternatively, the burden ratio management unit 604 selects a providing burden ratio such that the data utilization business operators who utilize the accumulated data bear a greater burden. As the providing burden ratio becomes higher, the other burden ratios (accumulation burden ratio and sharing burden ratio) decrease.

### <Information Disclosure>

The information disclosure unit 605 is means for disclosing various information related to an operation of the information distribution system. For example, the information disclosure unit 605 discloses the three burden ratios (accumulation burden ratio, sharing burden ratio, and providing information burden ratio) determined above to each of the actors (service business operator and data utilization business operator). Specifically, the information disclosure unit 605 transmits the three burden ratios to the service server 20 and the data utilization server 30.

Each actor uses the disclosed burden ratio and considers a cost burden and plans a strategy for the next period (next fiscal year) and so on.

Furthermore, the information disclosure unit 605 may disclose a parameter (for example, sharing demand coefficient, providing demand coefficient, and so on) for determining the consideration for data accumulation, data sharing, and data providing, respectively. Each actor may consider a data trading strategy, or the like, using the disclosed data. For example, the actor may refer to a dataset and transaction amount provided by other companies and handle a similar dataset in its own company, or determine a price of an existing dataset (holding source coefficient, sharing source coefficient, and providing source coefficient).

The storage unit 606 stores information necessary for the operations of the management server 11.

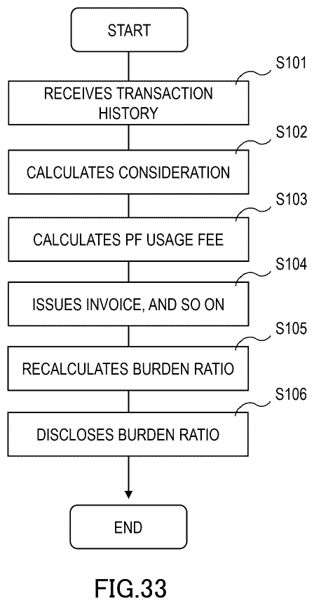

The operations of the management server 11 according to the first example embodiment will be described with reference to a flowchart. FIG. 33 is a diagram illustrating an example flowchart of the operations of the management server 11 according to the first example embodiment.

The management server 11 receives a transaction history from the service business operator (step S101).

The management server 11 calculates a consideration to be paid to each service business operator at a predetermined timing (step S102).

The management server 11 calculates a PF usage fee to be charged to service business operators and data utilization business operators (Step S103).

The management server 11 issues an invoice, or the like (payment statement, payment instruction statement, and invoice) to the service business operator and data utilization business operator (Step S104).

The management server 11 recalculates a burden ratio periodically or at a predetermined timing (Step S105).

The management server 11 discloses the recalculated burden ratio (Step S106).

As described above, in the information distribution system according to the first example embodiment, each actor reports its transaction history for a predetermined period (for example, one month) to the information distribution business operator, which is a platform operating organization. Based on the history obtained, the information distribution business operator calculates the PF usage fee per transaction type (accumulation, sharing, and providing information) of each actor. In addition, the information distribution business operator calculates the income and expenditure of each actor. The information distribution business operator considers the income and expenditure of each actor and calculates the burden ratio of each of accumulation, sharing, and providing so that the burdens of operating costs of the information distribution system become equal. More specifically, the information distribution business operator determines the platform usage fee so that the three entities, that is, the data accumulator, the data sharing destination, and the data providing destination, share the operating costs required for operating the information distribution system, and charges the three entities to pay the usage fee. By dividing the operating costs into three usage fees, the information distribution business operator can control the income and expenditure of each actor to some extent. For example, in the information distribution system, when accumulated data does not exist, data sharing and data providing do not occur, so the information distribution business operator determines the accumulation platform usage fee so as to give preferential treatment to the data accumulator. The data accumulator who is given a preferential usage fee can accumulate more data and provide many data to the data sharing destination or the data providing destination. As more accumulated data is registered in the information distribution system, data distribution becomes more active, and the data sharing destination and data providing destination can provide a better service to a user using the acquired data through the data distribution. As a result, a sustainable information distribution system is established.

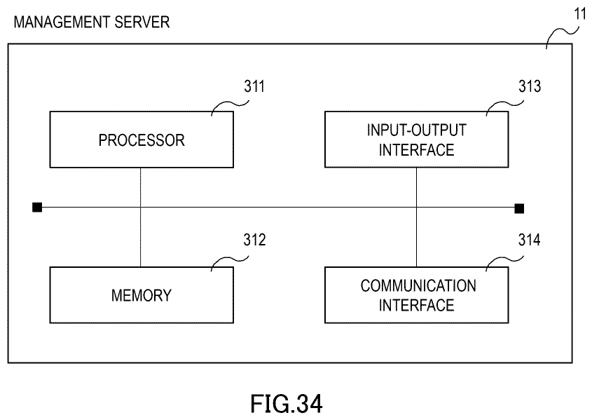

Next, a hardware configuration of an individual apparatus that constitutes the information distribution system will be described. FIG. 34 is a diagram illustrating an example of a hardware configuration of the management server 11.

The management server 11 can be configured by an information processing apparatus (a so-called computer) and has a configuration illustrated as an example in FIG. 34. For example, the management server 11 includes a processor 311, a memory 312, an input-output interface 313, a communication interface 314, and so on. The components such as the processor 311 are connected to an internal bus, and so on so that these components can communicate with each other.

However, the configuration shown in FIG. 34 is not intended to limit the hardware configuration of management server 11. The management server 11 may include hardware not illustrated or may be configured without the input-output interface 313 if desired. In addition, the number of components, such as the number of processors 311, included in the management server 11 is not limited to the example illustrated in FIG. 34. For example, a plurality of processors 311 may be included in the management server 11.

For example, the processor 311 is a programmable device such as a CPU (Central Processing Unit), an MPU (Micro Processing Unit), or a DSP (Digital Signal Processor). Alternatively, the processor 311 may be a device such as an FPGA (Field Programmable Gate Array) or an ASIC (Application Specific Integrated Circuit). The processor 311 executes various kinds of programs including an operating system (OS).

The memory 312 is a RAM (Random Access Memory), a ROM (Read-Only Memory), an HDD (Hard Disk Drive), an SSD (Solid State Drive), and so on. The memory 312 stores an OS program, an application program, and various kinds of data.

The input-output interface 313 is an interface for a display apparatus and an input apparatus not illustrated. For example, the display apparatus is a liquid crystal display and so on. For example, the input apparatus is an apparatus that receives user operations, and examples of the input apparatus include a keyboard and a mouse.

The communication interface 314 is a circuit, a module, and so on for performing communication with other apparatuses. For example, the communication interface 314 includes a NIC (Network Interface Card) and so on.

The functions of the management server 11 are realized by various kinds of processing modules. The processing modules are realized, for example, by causing the processor 311 to execute a program stored in the memory 312. In addition, this program can be recorded in a computer-readable storage medium. The storage medium may be a non-transient (non-transitory) storage medium, such as a semiconductor memory, a hard disk, a magnetic recording medium, or an optical recording medium. That is, the present invention can be embodied as a computer program product. In addition, the above program may be updated by downloading a program via a network or by using a storage medium in which a program is stored. In addition, the above processing modules may be realized by semiconductor chips.

As is the case with the distribution control server 10, the service server 20, or the like can each be configured by an information processing apparatus, and the basic hardware configuration of the distribution control server 10, the service server 20, or the like is the same as that of the management server 11. Thus, description of the basic hardware configuration of the distribution control server 10, the service server 20, or the like will be omitted.

The management server 11, which is an information processing apparatus, includes a computer and can realize its functions by causing the computer to execute a program. In addition, the management server 11 executes an authentication server control method by using this program.

### [Variations]

The configurations, operations, and so on of the information distribution system according to the above example embodiments are examples and do not limit the present system configuration, and so on.

The above example embodiment describes that the data sharing source or data providing source transmits a transaction history to the management server 11, and the management server 11 calculates considerations (consideration for sharing, consideration for accumulation) based on the history. However, the data sharing destination and data providing destination may also transmit the transaction history to the management server 11. The management server 11 may check the consistency related to the transaction history of each of the data sharing destination and data sharing source, and calculate the consideration with respect to the transaction in which the consistency is maintained.

The above example embodiment describes a configuration in which the information distribution business operator includes the distribution control server 10 and the management server 11. However, the operations of the information distribution business operator may be carried out by a single server apparatus. Specifically, the distribution control server 10 may include the functions of the management server 11, or the management server 11 may include the functions of the distribution control server 10.

The above example embodiment describes a case in which the user information database is configured inside the distribution control server 10, but the database may be established in an external database server or the like. That is, some of the functions of the distribution control server 10 may be implemented in another server. More specifically, the “data distribution control unit (data distribution control means)”, and so on, described above, can be implemented in any of the apparatuses included in the system.

While the data exchange between each apparatus (the distribution control server 10, the management server 11, the service server 20, and so on) is not limited to any particular mode, data exchanged between these apparatuses may be encrypted. It is desirable that personal information of a user and so on are transmitted and received between these apparatuses and encrypted data is transmitted and received in order to properly protect this information.

In the flowcharts and sequence diagrams used in the above description, a plurality of steps (processes) are sequentially described. However, the order of the execution of the steps performed in the individual example embodiment is not limited to the described order. In the individual example embodiment, the order of the illustrated steps may be changed to the extent that a problem is not caused on the content of the individual example embodiment. For example, individual processes may be executed in parallel.

The above example embodiments have been described in detail to facilitate the understanding of the present application disclosed and not to mean that all the configurations described above are needed. In addition, if a plurality of example embodiments have been described, each of the example embodiments may be used individually or a plurality of example embodiments may be used in combination. For example, part of a configuration according to one example embodiment may be replaced by a configuration according to another example embodiment. For example, a configuration according to one example embodiment may be added to a configuration according to another example embodiment. In addition, addition, deletion, or replacement is possible between part of a configuration according to one example embodiment and another configuration.

The industrial applicability of the present invention has been made apparent by the above description. That is, the present invention is suitably applicable, for example, to information distribution systems that distribute accumulated data related to a service provided to a user.

A part or the entirety of the example embodiments described above may be described as in the following supplementary notes, but is not limited to the followings.

### [Supplementary Note 1]

A system including:
a distribution control server that controls data accumulation to make data related to a service that is provided to a user from a data accumulator a target for data distribution, controls data sharing for a data sharing destination to acquire the accumulated data, and controls data providing for a data providing destination to acquire the accumulated data; and
a management server that charges an accumulation platform usage fee related to the data accumulation to the data accumulator, charges a sharing platform usage fee related to the data sharing to the data sharing destination, and charges a providing platform usage fee related to the data providing to the data providing destination.

### [Supplementary Note 2]

The system according to supplementary note 1, wherein the management server calculates the accumulation PF usage fee based on a number of cases in which the data accumulator has performed the data accumulation and an accumulation burden ratio, which defines a burden ratio of the data accumulation, calculates the sharing PF usage fee based on a number of cases in which the data sharing destination has performed the data sharing and a sharing burden ratio, which defines a burden ratio of the data sharing, and calculates the providing PF usage fee based on a number of cases in which the data providing destination has performed the data providing and a providing burden ratio, which defines a burden ratio of the data providing.

### [Supplementary Note 3]

The system according to supplementary note 2, wherein the management server determines the accumulation burden ratio, the sharing burden ratio, and the providing burden ratio based on income and expenditures of the data accumulator, the data sharing destination, and the data providing destination respectively.

### [Supplementary Note 4]

The system according to supplementary note 3, wherein the management server determines the accumulation burden ratio, the sharing burden ratio, and the providing burden ratio so as to give a preferential treatment to the data accumulator.

### [Supplementary Note 5]

The system according to supplementary note 4, wherein the management server acquires a data accumulation history related to a transaction of the data accumulation from the data accumulator, calculates a consideration for accumulation to be paid to the data accumulator based on the data accumulation history, and pays the calculated consideration for accumulation to the data accumulator.

### [Supplementary Note 6]

The system according to supplementary note 5, wherein the management server calculates the income and expenditure of the data accumulator by subtracting the accumulation PF usage fee from the consideration for accumulation paid to the data accumulator.

### [Supplementary Note 7]

The system according to supplementary note 6, wherein the management server determines the accumulation burden ratio so that the income and expenditure of the data accumulator becomes a surplus.

### [Supplementary Note 8]

The system according to any one of supplementary note 2 to 7, wherein the management server periodically recalculates the accumulation burden ratio, the sharing burden ratio, and the providing burden ratio.

### [Supplementary Note 9]

The system according to supplementary note 8, wherein the management server discloses the recalculated accumulation burden ratio, the recalculated sharing burden ratio and the recalculated providing burden ratio to the data accumulator, the data sharing destination and the data providing destination.

### [Supplementary Note 10]

A management server including:
a transaction history control unit that acquires a data accumulation history regarding data accumulation to make data related to a service that is provided to a user from a data accumulator a target for data distribution, acquires a data sharing history regarding data sharing for a data sharing destination to acquire the accumulated data, and acquires a data providing history regarding data providing for a data providing destination to acquire the accumulated data; and
a transaction settlement control unit that calculates an accumulation platform usage fee related to the data accumulation based on the data accumulation history and charges the calculated accumulation platform usage fee to the data accumulator, calculates a sharing platform usage fee related to the data sharing based on the data sharing history and charges the calculated sharing platform usage fee to the data sharing destination, and calculates a providing platform usage fee related to the data providing based on the data providing history and charges the calculated providing platform usage fee to the data providing destination.

### [Supplementary Note 11]

A control method of a management server, the control method including: acquiring a data accumulation history regarding data accumulation to make data related to a service that is provided to a user from a data accumulator a target for data distribution;
acquiring a data sharing history regarding data sharing for a data sharing destination to acquire the accumulated data;
acquiring a data providing history regarding data providing for a data providing destination to acquire the accumulated data;
calculating an accumulation platform usage fee related to the data accumulation based on the data accumulation history and charging the calculated accumulation platform usage fee to the data accumulator; calculating a sharing platform usage fee related to the data sharing based on the data sharing history and charging the calculated sharing platform usage fee to the data sharing destination; and
calculating a providing platform usage fee related to the data providing based on the data providing history and charging the calculated providing platform usage fee to the data providing destination.

### [Supplementary Note 12]

A computer-readable storage medium storing a program causing a computer mounted on a management server to perform processing for: acquiring a data accumulation history regarding data accumulation to make data related to a service that is provided to a user from a data accumulator a target for data distribution, acquires a data sharing history regarding data sharing for a data sharing destination to acquire the accumulated data, and acquires a data providing history regarding data providing for a data providing destination to acquire the accumulated data; and
calculating an accumulation platform usage fee related to the data accumulation based on the data accumulation history and charges the calculated accumulation platform usage fee to the data accumulator, calculates a sharing platform usage fee related to the data sharing based on the data sharing history and charges the calculated sharing platform usage fee to the data sharing destination, and calculates a providing platform usage fee related to the data providing based on the data providing history and charges the calculated providing platform usage fee to the data providing destination.

The entire disclosure of the above patent literature is incorporated herein by reference thereto. While the example embodiments of the present invention have thus been described, the present invention is not limited to these example embodiments. It is to be understood to those skilled in the art that these example embodiments are only examples and that various variations are possible without departing from the scope and sprit of the present invention. That is, the present invention of course includes various variations and modifications that could be made by those skilled in the art in accordance with the overall disclosure including the claims and the technical concept.

### REFERENCE SIGNS LIST

10 distribution control server
11 management server
20 service server
20-1 service server
20-2 service server
30 data utilization server
40 transaction server
50 terminal
60 hospital terminal
70-1 service business operator
70-2 service business operator
70-3 service business operator
70-4 service business operator
71 information distribution business operator
72 data utilization business operator
101 distribution control server
102 management server
201 communication control unit
202 user registration unit
203 ID linking unit
204 location information management unit
205 data distribution control unit
206 catalog information management unit
207 storage unit
301 communication control unit
302 ID linking control unit
303 data distribution request unit
304 data accumulation control unit
305 data distribution unit
306 transaction history reporting unit
307 transaction settlement unit
308 storage unit
311 processor
312 memory
313 input-output interface
314 communication interface
401 communication control unit
402 account opening unit
403 catalog information request unit
404 providing request processing unit
405 storage unit
501 communication control unit
502 personal information input unit
503 inquiry processing unit
504 account information input unit
505 storage unit
601 communication control unit
602 transaction history control unit
603 transaction settlement control unit
604 burden ratio management unit
605 information disclosure unit
606 storage unit

What is claimed is:

1. A system comprising:
a distribution control server that controls data accumulation to make data related to a service that is provided to a user from a data accumulator a target for data distribution, controls data sharing for a data sharing destination to acquire the accumulated data, and controls data providing for a data providing destination to acquire the accumulated data; and
a management server that charges an accumulation platform usage fee related to the data accumulation to the data accumulator, charges a sharing platform usage fee related to the data sharing to the data sharing destination, and charges a providing platform usage fee related to the data providing to the data providing destination.

2. The system according to claim 1, wherein the management server calculates the accumulation PF usage fee based on a number of cases in which the data accumulator has performed the data accumulation and an accumulation burden ratio, which defines a burden ratio of the data accumulation, calculates the sharing PF usage fee based on a number of cases in which the data sharing destination has performed the data sharing and a sharing burden ratio, which defines a burden ratio of the data sharing, and calculates the providing PF usage fee based on a number of cases in which the data providing destination has performed the data providing and a providing burden ratio, which defines a burden ratio of the data providing.

3. The system according to claim 2, wherein the management server determines the accumulation burden ratio, the sharing burden ratio, and the providing burden ratio based on income and expenditures of the data accumulator, the data sharing destination, and the data providing destination respectively.

4. The system according to claim 3, wherein the management server determines the accumulation burden ratio, the sharing burden ratio, and the providing burden ratio so as to give a preferential treatment to the data accumulator.

5. The system according to claim 4, wherein the management server acquires a data accumulation history related to a transaction of the data accumulation from the data accumulator, calculates a consideration for accumulation to be paid to the data accumulator based on the data accumulation history, and pays the calculated consideration for accumulation to the data accumulator.

6. The system according to claim 5, wherein the management server calculates the income and expenditure of the data accumulator by subtracting the accumulation PF usage fee from the consideration for accumulation paid to the data accumulator.

7. The system according to claim 6, wherein the management server determines the accumulation burden ratio so that the income and expenditure of the data accumulator becomes a surplus.

8. The system according to claim 2, wherein the management server periodically recalculates the accumulation burden ratio, the sharing burden ratio, and the providing burden ratio.

9. The system according to claim 8, wherein the management server discloses the recalculated accumulation burden ratio, the recalculated sharing burden ratio and the recalculated providing burden ratio to the data accumulator, the data sharing destination and the data providing destination.

10. A management server comprising:
at least one memory storing a set of instructions; and
at least one processor configured to execute the set of instructions to:
acquire a data accumulation history regarding data accumulation to make data related to a service that is provided to a user from a data accumulator a target for data distribution, acquire a data sharing history regarding data sharing for a data sharing destination to acquire the accumulated data, and acquire a data providing history regarding data providing for a data providing destination to acquire the accumulated data; and
calculate an accumulation platform usage fee related to the data accumulation based on the data accumulation history and charge the calculated accumulation platform usage fee to the data accumulator, calculate a sharing platform usage fee related to the data sharing based on the data sharing history and charge the calculated sharing platform usage fee to the data sharing destination, and calculate a providing platform usage fee related to the data providing based on the data providing history and charge the calculated providing platform usage fee to the data providing destination.

11. A control method of a management server, the control method comprising:
acquiring a data accumulation history regarding data accumulation to make data related to a service that is provided to a user from a data accumulator a target for data distribution;
acquiring a data sharing history regarding data sharing for a data sharing destination to acquire the accumulated data;
acquiring a data providing history regarding data providing for a data providing destination to acquire the accumulated data;
calculating an accumulation platform usage fee related to the data accumulation based on the data accumulation history and charging the calculated accumulation platform usage fee to the data accumulator;
calculating a sharing platform usage fee related to the data sharing based on the data sharing history and charging the calculated sharing platform usage fee to the data sharing destination; and
calculating a providing platform usage fee related to the data providing based on the data providing history and charging the calculated providing platform usage fee to the data providing destination.

12. (canceled)
